(19) United States
(12) Patent Application Publication
(10) Pub. No.: US 2014/0286475 A1
(43) Pub. Date: Sep. 25, 2014

(54) INTERFEROMETER AND OBJECT INFORMATION ACQUISITION SYSTEM

(71) Applicant: CANON KABUSHIKI KAISHA, Tokyo (JP)

(72) Inventors: Takashi Nakamura, Yokohama-shi (JP); Takeshi Kondoh, Kawasaki-shi (JP)

(21) Appl. No.: 14/296,952

(22) Filed: Jun. 5, 2014

Related U.S. Application Data
(63) Continuation of application No. PCT/JP2013/084871, filed on Dec. 26, 2013.

(30) Foreign Application Priority Data
Dec. 27, 2012 (JP) 2012-284432
Dec. 25, 2013 (JP) 2013-267150

(51) Int. Cl. G01T 1/16

(52) U.S. Cl. CPC G01T 1/16
USPC 378/51; 250/394; 250/336.1

(57) ABSTRACT

An interferometer includes a diffraction grating that forms a first pattern by diffracting X-rays; a shield grating that forms a second pattern by blocking one or more of the X-rays forming the first pattern; a detector that detects information on the second pattern by detecting X-rays from the shield grating; and a scanning unit that shifts relative positions of an object and a measurable range. In the interferometer, the detector acquires a first detection result by performing a detection while the measurable range and the object take first relative positions and acquires a second detection result by performing a detection while the measurable range and the object take second relative positions. In the interferometer, the scanning unit shifts the relative positions of the measurable range and the object so that a pattern of the first detection result and a pattern of the second detection result pattern have continuity.

### CROSS-REFERENCE TO RELATED APPLICATIONS

This application is a Continuation of International Patent Application No. PCT/JP2013/084871, filed Dec. 26, 2013, which claims the benefit of Japanese Patent Application No. 2012-284432, filed Dec. 27, 2012 and Japanese Patent Application No. 2013-267150, filed Dec. 25, 2013, all of which are hereby incorporated by reference herein in their entirety.

### TECHNICAL FIELD

The present invention relates to an interferometer using X-rays and an object information acquisition system including the interferometer.

### BACKGROUND ART

X-ray phase-contrast imaging is a method for causing contrast on the basis of phase shift of X-rays due to an object and thus acquiring information on the object (also referred to as object information, below). An example of the X-ray phase-contrast imaging is a method using Talbot interferometry.

The X-ray phase-contrast imaging using Talbot interferometry involves use of at least a diffraction grating for cyclically modulating the phase of X-rays and a detector. When spatially coherent X-rays pass through the diffraction grating, the phase of the X-rays is cyclically shifted with an effect of the shape of the diffraction grating. Thus, an interference pattern, called a self-image, is formed at a position a certain distance, called the Talbot length, away from the diffraction grating. When an object is placed between an X-ray generator and the detector, the detector can detect the interference pattern formed by the X-rays that have a phase and an amplitude shifted by the object, whereby the detector can acquire object information. In addition, by analyzing the detected results, information on a differential phase image of the object, information on a phase image, information on a dispersion image, or other information can be acquired.

The cycle of an interference pattern formed in the Talbot interferometry using X-rays, however, is generally smaller than the pixel size of the detector. Thus, directly detecting the interference pattern is difficult. To address this situation, a method for forming a moiré pattern by blocking, with a shield grating, some of X-rays that form an interference pattern and detecting the moiré pattern using a detector has been developed, the shield grating having a shielding structure in which screening portions, which block X-rays, and transmission portions, which allow X-rays to pass therethrough, are cyclically arranged. Use of this method enables acquisition of object information from the moiré pattern having a cycle larger than the cycle of the interference pattern. When a shield grating is used, an object is placed between the X-ray generator and the shield grating (between the X-ray generator and the diffraction grating or between the diffraction grating and the shield grating).

In the case where a detector detects an interference pattern, the range in which object information can be acquired (or measurable range) is a range in which an interference pattern is formed and the range is within a detection range detectable by the detector. On the other hand, in the case where a detector detects a moiré pattern, the range in which object information can be acquired is a range in which a moiré pattern is formed and the range is within the detection range of the detector. In other words, the range in which object information can be acquired depends on the sizes of the diffraction grating, the shield grating, and the detector. Thus, in order to increase the range in which object information can be acquired, the diffraction grating, the shield grating, and the detector have to have large areas. However, depending on a desired area, an increase in area of the diffraction grating, the shield grating, and the detector up to the desired area may be difficult.

In view of this situation, PTL 1 describes a Talbot interferometer that can acquire object information over a range larger than the measurable range by scanning the object.

### CITATION LIST

### Patent Literature

PTL 1: PCT Japanese Translation Patent Publication No. 2008-545981

Although PTL 1 describes scanning of an object, it does not describe the idea on which the scanning is based.

Thus, an object of the present invention is to provide an interferometer that can acquire information on an object by scanning the object and that can perform practically desirable scanning of the object. Another object of the present invention is to provide an object measurement system including the interferometer.

### SUMMARY OF INVENTION

An interferometer according to an aspect of the invention is an interferometer, including a diffraction grating that forms a first pattern by diffracting X-rays; a shield grating that forms a second pattern by blocking some of X-rays forming the first pattern; a detector that detects information on the second pattern by detecting X-rays from the shield grating; and a scanning unit that shifts relative positions of an object and a measurable range in which object information can be acquired, the measurable range being within a detection range of the detector. In the interferometer, the detector acquires a first detection result by performing a first detection while the measurable range and the object take first relative positions, and acquires a second detection result by performing a second detection while the measurable range and the object take second relative positions different from the first relative positions. In the interferometer, the scanning unit shifts the relative positions of the measurable range and the object by shifting at least one of a position at which the second pattern is formed, the detection range of the detector, and the object, and shifts the relative positions of the measurable range and the object so that a pattern of the first detection result and a pattern of the second detection result pattern have continuity.

Other aspects of the invention are clarified through embodiments described below.

Further features of the present invention will become apparent from the following description of exemplary embodiments with reference to the attached drawings.

### BRIEF DESCRIPTION OF DRAWINGS

FIGS. 1A to 1E illustrate examples of the configuration of an object information acquisition system according to a first embodiment.

FIGS. 2A and 2B illustrate examples of a shield grating used in the object information acquisition system according to the first embodiment.

FIG. 3 illustrates an example of the configuration of an object information acquisition system according to a second embodiment.

FIG. 4A illustrates a first detection result pattern acquired by the object information acquisition system according to the second embodiment and FIG. 4B illustrates first and second detection result patterns acquired by the object information acquisition system according to the second embodiment.

FIG. 5A illustrates a first detection result pattern acquired by the object information acquisition system according to the second embodiment; FIG. 5B illustrates first and second detection result patterns acquired by the object information acquisition system according to the second embodiment; FIG. 5C illustrates first, second, and third detection result patterns acquired by the object information acquisition system according to the second embodiment; and FIG. 5D illustrates first, second, third, and fourth detection result patterns acquired by the object information acquisition system according to the second embodiment.

FIG. 6 illustrates an example of the configuration of an object information acquisition system according to a third embodiment.

FIG. 7 illustrates the positions of a moiré pattern and a detection range according to Example 1.

FIGS. 8A to 8C illustrate the positions of a moiré pattern, a detection range, and an object according to Example 1.

FIGS. 9A and 9B illustrate the positions of a moiré pattern, a detection range, and an object according to Example 2.

FIGS. 10A to 10D illustrate the positions of a moiré pattern, a detection range, and an object according to Example 4.

FIGS. 11A to 11D illustrate the positions of a moiré pattern, a detection range, and an object according to Example 5.

FIG. 12 illustrates an example of a synthesized-X-rays' intensity distribution acquired by using patterns having no continuity.

FIGS. 13A to 13C illustrate the positions of a moiré pattern, a detection range, and an object according to Comparative Example 1.

FIGS. 14A and 14B illustrate the positions of a moiré pattern, a detection range, and an object according to Comparative Example 2.

### DESCRIPTION OF EMBODIMENTS

The inventors of the present invention have found that, when an object is scanned, it is preferable that detection result patterns (interference patterns or moiré patterns) acquired by scanning have continuity.

A preferable embodiment of the present invention provides an interferometer that can acquire information on an object by scanning the object and that can scan the object in such a manner that detection result patterns acquired by scanning have continuity. Another preferable embodiment of the present invention provides an object information acquisition system including the interferometer.

The above-described interferometer according to one aspect of the present invention includes a scanning unit that shifts relative positions of a measurable range and an object by shifting at least one of the position at which the second pattern is formed, a detection range of the detector, and the object.

In the present invention and in this description, a measurable range represents a range in which object information can be acquired and the range is within a detection range of the detector (for example, a range in which detection pixels are present). In the case where an interference pattern is directly detected, the measurable range represents a range in which an interference pattern is formed and the range is within the detection range of the detector. In the case where a moiré pattern is detected, the measurable range represents a range in which a moiré pattern is formed and the range is within the detection range of the detector. Both of these ranges are displayed on a plane of the detection range of the detector.

The term “range” used in this invention and this description may be replaced by “region”.

In embodiments described below, an interferometer is a Talbot interferometer. A Talbot interferometer according to some embodiments includes a diffraction grating, which forms interference patterns (also referred to as first patterns, below) by diffracting X-rays, and a shield grating, which forms moiré patterns (also referred to as second patterns, below) by blocking part of the X-rays that form the interference patterns. The interferometer also includes a detector, which detects information on moiré patterns by detecting X-rays from the shield grating, and a scanning unit, which scans an object. The scanning unit scans the object by shifting at least one of the position at which a second pattern is formed, a detection range of the detector, and the object so as to shift the relative positions of the measurable range and the object. When the detector is shifted, the detection range is usually shifted accordingly. Thus, unless otherwise noted below, when the detector is shifted, the detection range is shifted accordingly. Examples of a method for shifting the position at which the second pattern is formed include shifting the diffraction grating, shifting the shield grating, shifting an X-ray generator, described below, and shifting a radiation-source grating, described below.

In the case of directly detecting a first pattern using a detector without using a shield grating, the scanning unit shifts at least one of the position at which a first pattern is formed, the detection range of the detector, and the object. Here, examples of the method for shifting the position at which the first pattern is formed include shifting a diffraction structure, shifting an X-ray generator, which is described below, and shifting a ray-generator grating, which is described below.

The detector acquires a first detection result by performing a first detection when the measurable range and the object take first relative positions and acquires a second detection result by performing a second detection when the measurable range and the object take second relative positions, different from the first relative positions. The scanning unit shifts the relative positions of the measurable range and the object from the first relative positions to the second relative positions between the first detection and the second detection of the detector. If needed for a pattern contained in the first detection result and a pattern contained in the second detection result to have continuity, the scanning unit shifts the relative positions of the position at which the second pattern is formed and the detector. The pattern contained in the first detection result may be referred to as a first detection result pattern and the pattern contained in the second detection result may be referred to as a second detection result pattern.

In this description and the present invention, the relative positions represent relative positions on the plane within the detection range of the detector. For example, the relative positions of the shield grating and the object represent relative positions of a projection image of the shield grating and a projection image of the object obtained by projecting the shield grating and the object on the detection range plane. Since the positions at which the projection images are formed are determined in accordance with the distance between the X-ray generator, an object that is to be projected (the shield grating and the object in the above-described example), and the detection range plane, the actual projection is not required. The relative positions of a measurable range and an object represent relative positions of the measurable range within the detection range of the detector and the projection image of the object acquired by projecting the object on the detection range plane.

The detection results are transmitted to a computation unit connected to the Talbot interferometer and the computation unit acquires at least one of phase information, absorption information, and dispersion information on the object.

Both the first pattern and the second pattern formed by X-rays that have a phase and an intensity (amplitude) that are changed by the object include object information. Thus, in this invention and this description, detecting the information on a first or second pattern formed by X-rays that have a phase and an intensity that are changed by the object means detecting object information. Specifically, if a detector acquires (detects) information on a first or second pattern formed by the X-rays that have a phase and an intensity at least one of which is changed by the object, the Talbot interferometer is a Talbot interferometer that can acquire object information. The Talbot interferometer according to some embodiments scans an object and detects, multiple times, information on a first or second pattern formed by X-rays that have a phase and an intensity changed by the object. Thus, object information can be acquired within the range that is larger than the measurable range. Specifically, a Talbot interferometer according to some embodiments can acquire object information within an area that is larger than the smallest one of the areas of the range in which the interference pattern is formed, a grid region of the shield grating, and the detection range of the detector.

As described above, the inventors of the present invention have found that, when a computation device acquires object information using information on detection results acquired by the Talbot interferometer, it is preferable that patterns included in the detection results have continuity. The reasons why it is preferable are described as in the following two points.

The first point is that, if detection result patterns have continuity, the time taken for the computation unit to acquire object information may be reduced compared to the time taken in the existing case. The second point is that, depending on the method for acquiring object information with the computation unit, the detection result patterns having continuity enable an increase in accuracy of object information or acquisition of object information that could not be acquired if the detection result patterns do not have continuity. These two reasons are described below taking the Talbot interferometer that detects second patterns formed by using a shield grating as an example. Here, the first detection result and the second detection result are transmitted to the computation unit and the computation unit computes phase information on the object using the first detection result and the second detection result.

(1) Regarding the reason why the time taken for the computation unit to acquire object information can be reduced compared to that taken in the existing case.

A case is assumed where the first detection result and the second detection result have portions (overlapping portions) that are measurement results of the same portion of the object. Here, when object information is computed from each of the first detection result and the second detection result, the object information for the overlapping portions is computed twice. The inventors of the present invention have found that, in such a case, if the moiré patterns of the detection results are continuous with each other, a synthetic moiré pattern can be acquired by synthesizing the detection results and can perform phase retrieval using the synthetic moiré pattern. Thus, acquiring a synthetic moiré pattern by synthesizing the first detection result and the second detection result and performing phase retrieval using the synthetic moiré pattern enable reduction of the time taken for the phase retrieval by the time taken for phase retrieval of the overlapping portion. The method of phase retrieval is not particularly limited and examples of the method for phase retrieval include the Fourier transform, fringe scanning, and an intermediate between the Fourier transform and fringe scanning.

If the moiré patterns of the detection results are not continuous with each other, in a synthetic moiré pattern acquired by splicing the detection results (for example, a first detection result and a second detection result) together, a portion of the cycle near the splice is disordered. This disorder of the cycle may reduce the accuracy of differential-phase-image information at the time of phase retrieval or prevent the phase retrieval itself.

As described above, when moiré patterns of multiple detection results are continuous with each other, object information can be computed using a synthetic moiré pattern. Thus, the time required for computing object information may be reduced compared to the time required for computing object information from each detection result and then splicing the pieces of computed information.

(2) Regarding the reason why, depending on the method for acquiring object information with the computation unit, the detection result patterns having continuity enable an increase in accuracy of object information or acquisition of object information that could not be acquired if the detection result patterns do not have continuity.

Examples of a method for acquiring object information include acquiring object information for a region corresponding to specific pixels from only detection results of the specific pixels and acquiring object information for a region corresponding to specific pixels from detection results of the specific pixels and pixels around the specific pixels. Here, object information for a region corresponding to specific pixels represents information on a region of an object (part of an object) through which X-rays detected by specific pixels have passed. An example of the former method is acquiring information on a differential phase image of an object by performing phase retrieval using fringe scanning. An example of the latter method, on the other hand, is acquiring information on a differential phase image of an object by performing phase retrieval using the Fourier transform or an intermediate of the Fourier transform and fringe scanning. In order to acquire three unknowns from one detection result, a typical Fourier transform acquires phase information on an object in a region corresponding to specific pixels using detection results corresponding to at least three pixels. However, at the edges of the measurable range, some of pixels around the specific pixels are absent. Thus, object information for regions corresponding to pixels at the edges is computed from less detection results than detection results used to compute object information for regions corresponding to other pixels. Consequently, the object information for regions corresponding to pixels at the edges may have lower accuracy than the object information for regions corresponding to other pixels. Moreover, as in the case of a line detector in which pixels are arranged in only an x direction, if the number of pixels arranged in a y direction is small, a pattern in the y direction fails to be acquired, whereby part of object information (information such as a differential phase image acquired from differentiation in the y direction or a differential dispersion image acquired from differentiation in the y direction) fails to be acquired.

In an interferometer according to some embodiments, moiré patterns of detection results are continuous with each other. Thus, the computation unit to which the interferometer transmits information on detection results can acquire object information using a synthetic moiré pattern acquired by synthesizing the detection results. Acquisition of object information using the synthetic moiré pattern can reduce the edges of moiré patterns (portions of the moiré patterns detected at the edges of the measurable range) compared to those in the case where object information is acquired from the detection results. Thus, reduction in accuracy can be minimized. For example, in the case where a detector including 4×4 pixels is used, 12 pixels are located at the edges of a moiré pattern in each of the first and second detection results (24 pixels in total). In the case of assuming a moiré pattern of 4×8 pixels acquired by synthesizing first and second detection results, 20 pixels are regarded as being located at the edges of the synthetic moiré pattern. Thus, regions that may have lower accuracy than other regions correspond to 24 pixels in the case of acquiring object information from the detection results and correspond to 20 pixels in the case of acquiring object information from the synthetic moiré pattern. Actually, portions around the edges may have low accuracy. For ease of explanation, however, the case where only the edges have low accuracy is assumed. Even in the case of using a line detector in which pixels are arranged in only the x direction, a pattern in the y direction can be acquired by shifting the relative positions of the object and the measurable range in the y direction and acquiring a synthetic moiré pattern. Consequently, acquirable object information increases. Here, the y direction is assumed to be present on the xy plane perpendicular to an optical axis and is equal to one of directions of the cycle of a moiré pattern formed on the xy plane. The optical axis here represents the center axis of an X-ray beam emitted from the X-ray generator.

Acquisition of object information from a synthetic moiré pattern in this manner can minimize reduction in accuracy compared to the case where object information is acquired from the detection results. A synthetic moiré pattern used to minimize reduction in accuracy may be any pattern with which object information for regions corresponding to at least edges of moiré patterns can be acquired from multiple detection results. For example, in the case where, after detecting a first detection result, a detector is lowered while an object is fixed and the detector detects a second detection result, a synthetic moiré pattern in which only a lower end portion of the first detection result and an upper end portion of the second detection result are synthesized may be used. The use of this synthetic moiré pattern in which only a lower end portion of the first detection result and an upper end portion of the second detection result are synthesized can minimize reduction in accuracy of object information corresponding to the lower end portion of the first detection result and the upper end portion of the second detection result. When the object information acquired from the synthetic moiré pattern, object information acquired from the first detection result, and object information acquired from the second detection result are spliced together, object information for a range larger than a range of information acquired from only a first or second detection result can be acquired. Alternatively, object information may be acquired from each of a first synthetic moiré pattern, in which a first detection result and the upper end portion of the second detection result are synthesized, and a second synthetic moiré pattern, in which the lower end portion of the first detection result and the second detection result are synthesized, and the object information on the first synthetic moiré pattern and the object information on the second synthetic moiré pattern may be spliced together.

From the above-described two points, it is preferable that moiré patterns included in detection results detected by a Talbot interferometer be continuous with each other. Now, a method for scanning an object with an interferometer according to some embodiments in such a manner that moiré patterns have continuity will be described below.

In this invention and this description, differential-phase-image information and phase-image information are collectively referred to as phase information. The computation unit may compute, as phase information on an object, both of differential-phase-image information and phase-image information or may compute either one of information. In this invention and this description, dispersion information represents dispersion-image information (including a dark field image) and absorption information represents absorption-image information. In this invention and this description, differential-phase-image information is information constituting a differential phase image and represents numerical information on a differential phase on multiple coordinates. The same applies to phase-image information, dispersion-image information, and absorption-image information.

In the case where information on an interference pattern is directly detected by the detector without using a shield grating, the moiré pattern in the above description can be read as an interference pattern.

Referring now to the drawings, embodiments of the present invention will be specifically described.

### First Embodiment

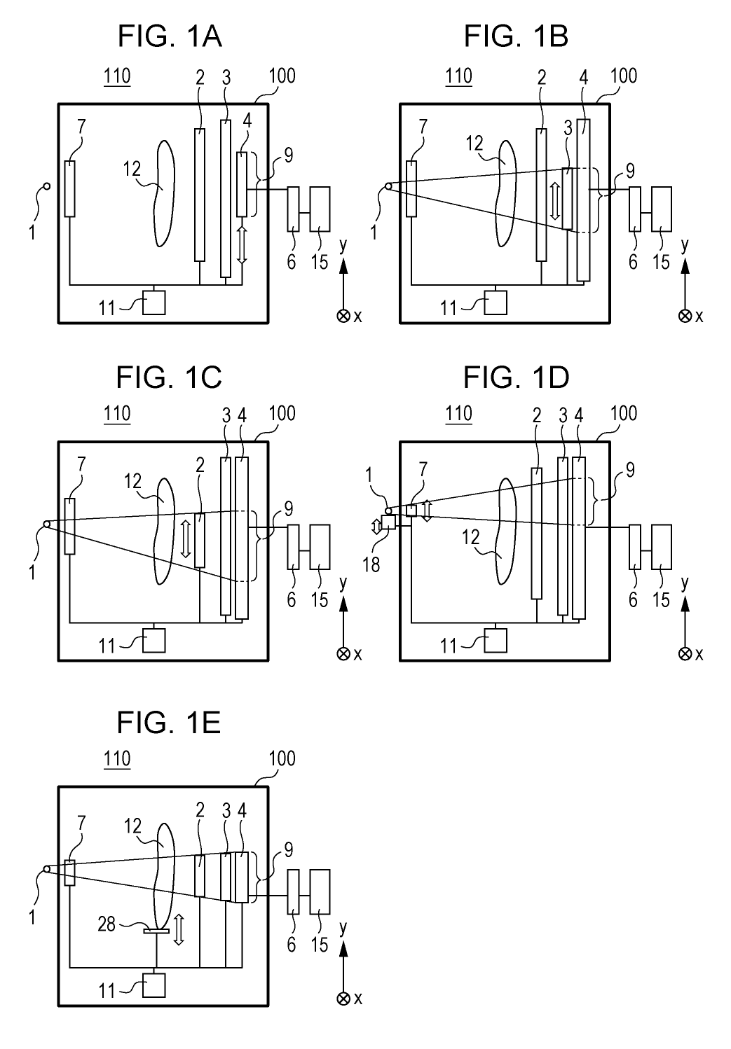

FIG. 1A to FIG. 1E illustrate examples of the configuration of an object information acquisition system 110 according to a first embodiment. A Talbot interferometer (also simply referred to as an interferometer, below) 100 includes a radiation-source grating 7, which blocks some of X-rays from an X-ray generator 1, a diffraction grating 2, which forms an interference pattern by diffracting the X-rays from the radiation-source grating, and a shield grating 3, which blocks some of X-rays that form the interference pattern. The interferometer 100 also includes a detector 4, which detects the X-rays from the shield grating 3, and a scanning unit 11, which scans an object by shifting the relative positions of a measurable range 9 and an object 12. In the examples illustrated in FIGS. 1A to 1E, the interferometer 100, a computation unit 6, the X-ray generator 1, and an image display unit 15 constitute the object information acquisition system 110. The computation unit 6 acquires object information using multiple detection results from the detector. If display of images is not required, the object information acquisition system 110 does not have to include an image display unit 15. In the examples illustrated in FIGS. 1A to 1E, the detector 4 is physically connected to the computation unit 6 and the image display unit 15 is physically connected to the computation unit 6. However, the detector 4 and the image display unit 15 do not have to be physically connected to the computation unit 6 at adjacent positions and they may be connected to the computation unit 6 via wireless communications, LAN, internet, or by other means.

Each component of the object information acquisition system 110 will be described below.

The X-ray generator 1 irradiates the interferometer with X-rays. The X-rays emitted by the X-ray generator 1 may be continuous X-rays or characteristic X-rays. In this invention and this description, X-rays represent electromagnetic waves having an energy of 2 keV or higher but 100 keV or lower. In addition, a wavelength selection filter may be disposed on the path of the X-rays emitted by the X-ray generator 1. The wavelength selection filter may be disposed between the X-ray generator 1 and the interferometer or the wavelength selection filter may be included in the interferometer.

The radiation-source grating 7 includes screening portions and transmission portions and thus spatially divides the X-rays emitted by the X-ray generator 1 into pieces. Consequently, each transmission portion serves as a virtual X-ray generator, whereby the spatial coherence of the X-rays improves. The size of the transmission portions of the radiation-source grating 7 is designed so that the X-rays from the radiation-source grating 7 have such a high spatial coherence as to be able to form an interference pattern by being diffracted by the diffraction grating 2. Such a method for performing the Talbot interferometry using the Lau effect is called Talbot-Lau interferometry. If the coherence of the X-rays from the X-ray generator 1 is sufficiently high, the radiation-source grating 7 is not needed.

The X-rays that are emitted by the X-ray generator 1 and that have passed through the radiation-source grating 7 change their phase and intensity, after passing through the object 12, in accordance with the index of refraction and the shape of the object. In FIGS. 1A to 1E, the object 12 is disposed between the radiation-source grating 7 and the diffraction grating 2, but the object 12 may be disposed between the diffraction grating 2 and the shield grating 3.

The diffraction grating 2 diffracts X-rays from the X-ray generator and forms an interference pattern at the Talbot length. The interference pattern has lit portions and unlit portions, which are cyclically disposed. In this description, portions at which the X-rays have a high intensity are defined as lit portions and portions at which the X-rays have a low intensity are defined as unlit portions. A diffraction grating 2 according to some embodiments is a phase diffraction grating (phase grating) and has a cyclic structure in which phase progress portions and phase retardation portions are cyclically arranged. Alternatively, an amplitude diffraction grating that modulates the intensity of X-rays may be used as a diffraction grating 2. Nevertheless, a phase diffraction grating is preferable to an amplitude diffraction grating because the phase diffraction grating loses a smaller amount of X-rays than the amplitude diffraction grating. The diffraction grating 2 may have a structure in which phase retardation portions and phase progress portions are one-dimensionally arranged (one-dimensional cyclic structure) or a structure in which phase retardation portions and phase progress portions are two-dimensionally arranged (two-dimensional cyclic structure). Typical phase gratings are designed so that the phase of X-rays that have passed through the phase retardation portions is shifted a π or π/2 radian with respect to the phase of the X-rays that have passed through the phase progress portions, but the phase may be shifted other amounts. In this description, a phase grating that shifts the phase a π radian is referred to as a π grating and a phase grating that shifts the phase a π/2 radian is referred to as a π/2 grating. In the case where a π grating diffracts parallel X-rays (straight X-rays such as synchrotron radiation), that is, in the case where the magnification is one, the cycle of an interference pattern is ½ the cycle of the π grating. When the π/2 grating diffracts parallel X-rays, the cycle of an interference pattern is equal to the cycle of the π/2 grating. By multiplying the interference pattern acquired by diffracting parallel X-rays by the magnification, the cycle of the interference pattern acquired by diffracting dispersed X-rays can be computed. The magnification is a value (L2/L1) obtained by dividing a distance L2 between the X-ray generator (or a radiation-source grating when used) and the interference pattern (or a shield grating when used or a detection surface of the detector when the shield grating is not used) by a distance L1 between the X-ray generator (or the radiation-source grating when used) and the diffraction grating.

The shield grating 3 has a cyclic structure in which screening portions 13, which block X-rays, and transmission portions 21, which allow X-rays to pass therethrough, are arranged. Thus, the shield grating 3 blocks some of X-rays that are formed into an interference pattern by the diffraction grating 2. Consequently, a moiré pattern according to a combination of the interference pattern and the pattern of the shield grating is formed. A typical example of the shield grating is an absorptive shield grating (absorption grating) in which screening portions 13 are made of a material having a high X-ray absorptivity. Alternatively, a reflective shield grating that blocks X-rays by reflecting the X-rays may be used.

In the case of an absorptive shield grating 3, the screening portions 13 are made of a material having a high X-ray absorptivity. Examples of a material having a high X-ray absorptivity include gold, platinum, tungsten, tantalum, molybdenum, and an alloy containing at least one of these metals. In the case of the absorptive shield grating 3, the transmission portions are made of a material having a high X-ray transparency. Examples of a material having a high X-ray transparency include a resin or silicone such as a photosensitive resist. The transmission portions may be hollow, instead.

Although the screening portions 13 do not have to completely block X-rays, the screening portions 13 are required to block X-rays to such a degree that a moiré pattern is formed by blocking part of an interference pattern. Thus, even in the case where the screening portions 13 of the shield grating 3 are made of the above-described material having a high X-ray absorptivity, the screening portions 13 have to have a certain thickness in the direction in which X-rays travel. Thus, an increase in area of the screening portions 13 may be more difficult than an increase in area of the phase grating or the detector or the screening portions 13 may cost more than the phase grating or the detector.

When the screening portions 13 of the shield grating block some of X-rays that form an interference pattern, a moiré pattern is formed. Typically, the cycle of a moiré pattern is determined by the cycles of overlapping cyclic structures and the directions of the cycles.

In the case where a moiré pattern is formed using a cyclic structure of a cycle pₐ and a cyclic structure of a cycle p_{b} and the directions of the cycles intersect at an angle θ (θ=0 when the cycles are parallel), the cycle of the moiré pattern is expressed by Expression (1), below:

pₐ×p_{b}/(pₐ²×sin²θ+(p_{b} cos θ−pₐ)²)^{1/2} Expression (1)

When the cycle of the interference pattern formed on the shield grating is substituted with the cycle pₐ, the cycle of the shield grating is substituted with the cycle p_{b}, the angle between the direction of the cycle of the interference pattern formed on the shield grating and the direction of the cycle of the shield grating is substituted with an angle θ, the cycle of a moiré pattern formed by the Talbot interferometer can be computed.

The cycles of the screening portions 13 and the transmission portions 21 or the directions of the cycles may be determined in consideration of the shape of the interference pattern and a desired shape of a moiré pattern.

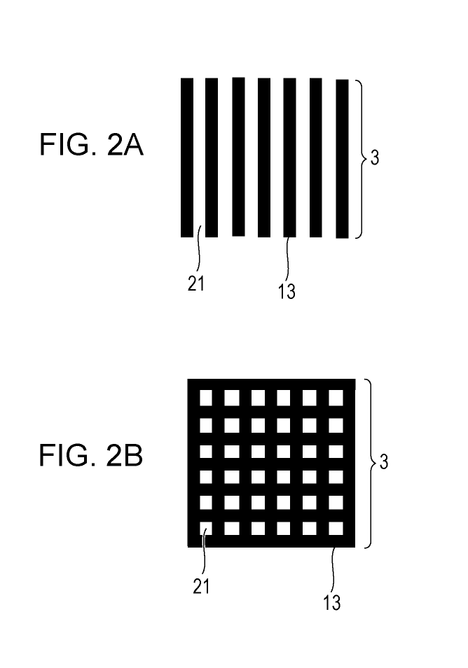

FIG. 2A and FIG. 2B illustrate examples of the shield grating 3. The shield grating 3 illustrated in FIG. 2A has a cyclic structure (one-dimensional cyclic structure) in which the screening portions 13 and the transmission portions are arranged in one direction. The shield grating 3 may have a cyclic structure (two-dimensional cyclic structure) in which the screening portions 13 and the transmission portions 1 are arranged in two directions. For example, a shield grating 3 having a two-dimensional cyclic structure in the form of a lattice, as illustrated in FIG. 2B, may be used. Alternatively, the cyclic structure of the shield grating 3 may be a structure in which the screening portions and the transmission portions are arranged in a checkered pattern.

One example of a method for fabricating the shield grating 3 is plating. A structure having a high aspect ratio is formed from a photosensitive resist or Si on a flat surface of a substrate and the space between the structure and the surface is filled with plating. Alternatively, a structure having a high aspect ratio may be formed by etching a silicon substrate and then filled with plating. The structure having a high aspect ratio thus formed constitutes transmission portions. The plating may be of any material having a high X-ray absorptivity. However, a material such as an alloy containing at least one of gold, platinum, and a set of gold and platinum is preferably used since plating of such an alloy is relatively easy. The structure formed by being filled with plating constitutes screening portions.

The detector 4 is a detector that detects X-rays from the shield grating 3. The detector 4 can acquire information on two-dimensional X-rays' intensity distribution in accordance with the intensity of the emitted X-rays, since pixels are arranged in two directions within the detection range. Instead of acquiring information on two-dimensional X-rays' intensity distribution, information on one-dimensional X-rays' intensity distribution may be acquired using a line sensor. As described above, the detector 4 acquires a first detection result by performing a first detection when a measurable range and an object take first relative positions and acquires a second detection result by performing a second detection when the measurable range and the object take second relative positions. The first and second detection results are transmitted to the computation unit 6. In the case where the detection time (exposure time) of the detector is short and the amount by which each component shifts within the detection time is small, the detector may perform detection while the scanning unit shifts the relative positions of the measurable range and the object or the relative positions of the interference pattern and the detector.

The scanning unit 11 shifts the relative positions of the measurable range and the object by shifting at least one of the position at which the interference pattern is formed, the shield grating 3, the detector 4, and the object 12.

The scanning unit 11 shifts the relative positions of the measurable range and the object from the first relative positions to the second relative positions between the first detection and the second detection performed by the detector. The scanning unit 11 also shifts, as appropriate, the relative positions of the moiré pattern and the detector (or an interference pattern when the interference pattern is to be directly detected) between the first detection and the second detection so that the first detection result pattern and the second detection result pattern have continuity. The position at which the interference pattern is formed is determined by the position of the radiation-source grating 7 or the diffraction grating 2. Thus, the scanning unit 11 can change the position at which the interference pattern is formed by shifting at least one of the radiation-source grating 7 and the diffraction grating 2.

The scanning unit 11 can include, for example, an actuator and an instructing unit. In this structure, the actuator can shift at least one of the radiation-source grating 7, the diffraction grating 2, the shield grating 3, the detector 4, and the object 12 in accordance with an instruction from the instructing unit.

FIG. 1A illustrates a form in which the scanning unit 11 shifts the detector 4. In this case, since the relative positions of the detection range of the detector and the object are shifted, the relative positions of the measurable range and the object are shifted. FIG. 1B illustrates a form in which the scanning unit 11 shifts the shield grating 3. In this case, since relative positions of the position at which a moiré pattern is formed and the object are shifted, the relative positions of the measurable range and the object are shifted. FIG. 1C illustrates a form in which the scanning unit 11 shifts the diffraction grating. In this case, since the position at which an interference pattern is formed is shifted, the relative positions of the position at which a moiré pattern is formed and the object are shifted and the relative positions of the measurable range and the object are shifted. FIG. 1D illustrates a form in which the scanning unit 11 shifts the radiation-source grating 7. In this case, since the relative positions of the diffraction grating and the position of an opening of the radiation-source grating, functioning as a virtual X-ray generator, are shifted, the position at which an interference pattern is formed is shifted and the relative positions of the position at which a moiré pattern is formed and the object are shifted. Thus, the relative positions of the measurable range and the object are shifted. In the form illustrated in FIG. 1D, the scanning unit 11 shifts an X-ray generator stand 18, which fastens the X-ray generator, in accordance with shift of the radiation-source grating. The shift of the X-ray generator stand enables emission of X-rays from the opening of the radiation-source grating regardless of the amount of shift of the radiation-source grating. FIG. 1E illustrates a form in which the scanning unit 11 shifts the object 12 by shifting an object stand 28. Thus, the relative positions of the measurable range and the object are shifted. The scanning unit may shift two or more components. For example, the scanning unit may shift the diffraction grating and the shield grating or the shield grating and the detector. When two or more components are shifted, these components may be concurrently shifted by being fastened to each other. Alternatively, when the X-ray generator has a sufficiently high coherence and the interferometer 100 does not include a radiation-source grating, the relative positions of a measurable range and an object may be shifted by shifting the relative positions of the X-ray generator and the diffraction grating with shift of the X-ray generator. For example, in the case where the interferometer includes an X-ray generator stand, the X-ray generator can be shifted by the scanning unit shifting the X-ray generator stand.

The scanning unit shifts the relative positions of the measurable range and the object so that the first detection result pattern and the second detection result pattern, that is, moiré patterns detected before and after the shift by the scanning unit (interference patterns when interference patterns are directly detected) have continuity.

Here, the expression that moiré patterns have continuity means that, when an object is not disposed, the splice of a synthesized pattern acquired by splicing first and second detection result patterns together has a cycle that is equal to the cycles of the first and second detection result patterns. In this invention and this description, however, when the cycle of the splice falls within the range of ±10% of the cycle of the first detection result pattern (also simply referred to as a first detection result cycle, below), the cycle of the splice and the cycle of the first detection result pattern are regarded as being equal to each other. Similarly, when the cycle of the splice falls within the range of ±10% of the cycle of the second detection result pattern (also simply referred to as a second detection result cycle, below), the cycle of the splice and the cycle of the second detection result pattern are regarded as being equal to each other. In addition, when the cycle of the first detection result pattern falls within the range of ±10% the cycle of the second detection result pattern, the cycles of the first and second detection result patterns are regarded as being equal to each other. Specifically, when two cycles of the three cycles, that is, the cycle of the splice and the cycles of the first and second detection result patterns, fall within the range of ±10% the cycle of the remaining one cycle, the cycle of the splice and the cycles of the first and second detection result patterns are regarded as being equal to one another.

A method for shifting each component with the scanning unit in order for the first detection result pattern and the second detection result pattern to have continuity will be described below. In the following description, shift in the y direction will be described. However, the “y direction” is not meant to be the only direction in relation to the detector. However, in the case where multiple pixels are two-dimensionally arranged in a matrix form in the detector, it is preferable that either one of the directions of the arrangement is defined as the y direction.

The scanning unit shifts the relative positions of the measurable range and the object d_{y}×(n_{y}−a) in the y direction between the first detection and the second detection. Here, in order for the first detection result pattern and the second detection result pattern to have continuity, the relative positions of the position of the moiré pattern and the detector are shifted (b_{y}−a)×d_{y}+M_{y}×d_{y}×n between the first detection and the second detection. In the above-described expression, a and n are integers, d_{y} is a pixel size of the detector in the y direction, and n_{y} is a number of pixels arranged in the measurable range in the y direction (that is, a value obtained by dividing the width of the measurable range in the y direction by d_{y}). In addition, M_{y} is a value obtained by dividing the cycle of the moiré pattern in the y direction by the pixel size (d_{y}) and b_{y} is a remainder obtained when n_{y} is divided by M_{y} provided that the quotient and the remainder are integers zero or larger. In this invention and this description, this case may be expressed as b_{y}=mod [n_{y}, M_{y}]. The cycle (M_{y}×d_{y}) of the moiré pattern used for computation of M_{y} is a cycle of the moiré pattern when the object is not disposed between the X-ray generator and the detector and can be computed by Expression (1), described above. In order to acquire the cycle of the moiré pattern, M_{y} has to be larger than two and may not be an integer. Here, a<n_{y}. Alternatively, (b_{y}−a)×d_{y}+M_{y}×d_{y}×n may be equal to M_{y}×d_{y}×n₁ (Here, n₁ is an integer different from n). Alternatively, (b_{y}−a)×d_{y}+M_{y}×d_{y}×n may be zero. Here, although the position of the moiré pattern and the position of the detection range are fixed, for ease of description, the relative positions of the position of the moiré pattern and the detection range of the detector are regarded as being shifted zero.

When a=0, the range detected during the first detection (detection for acquiring a first detection result) and the range detected during the second detection do not overlap with each other and are adjacent to each other. On the other hand, when a is one or larger, the range detected during the first detection and the range detected during the second detection overlap with each by an amount corresponding to a pixels. Although the total measurable range is reduced by the amount corresponding to the overlapping portions compared to the case where a is zero or smaller, the accuracy improves since the noise of object information for the overlapping portions decreases. On the other hand, when a is minus one or smaller, an undetected range arises between the range detected during the first detection and the range detected during the second detection. Although the total measurable range increases due to the amount of the arising undetected range compared to the case where a is zero or larger, object information over the undetected range is difficult to acquire. In this manner, the value a can be determined in consideration of the accuracy of acquired object information, the size of the measurable range, the total number of times of detection, or other conditions. Moreover, the value a may be designed to be changeable by users in accordance with the purpose of measurement. In this case, a user may adjust a directly or by selecting a measurement mode. For example, the scanning unit and a mode selection unit may be designed so that a becomes a negative integer with a selection of a quick measurement mode, a becomes zero with a selection of a normal measurement mode, and a becomes a positive integer with a selection of a precise measurement mode.

In order to shift the relative positions of the position of the moiré pattern and the detector a distance larger than zero or smaller than zero, at least one of the position of the moiré pattern and the detector may be shifted.

In order to shift the position of the moiré pattern, at least one of the X-ray generator (an opening of a radiation-source grating, functioning as a virtual X-ray generator, when the radiation-source grating is used), the phase grating, and the shield grating may be shifted.

The amount of shift of the X-ray generator projected over the detection range of the detector (also simply referred to as an X-ray generator on the detector, below) is equal to the amount of shift of the position of a moiré pattern formed in the detection range (also simply referred to as a moiré pattern on the detector, below). When the X-ray generator on the detector is shifted (b_{y}−a)×d_{y} in the y direction while the phase grating and the shield grating are fixed, the position of a moiré pattern on the detector is shifted (b_{y}−a)×d_{y} in the y direction. This shift is expressed using the amount of shift of the phase. If one cycle of a moiré pattern is a 2π radian, the amount of shift of the moiré pattern can be expressed in radian units by dividing the amount of shift of the moiré pattern by a cycle of the moiré pattern (M_{y}×d_{y}) and multiplying the resultant by 2π. Thus, the amount of shift of the moiré pattern (in radian units) φ={(b_{y}−a)×d_{y}}/M_{y}/d_{y}×2π. In order to shift the phase of the moiré pattern an amount of φ, the phase of the X-ray generator may also be shifted an amount of φ. The distance required to shift the phase of the X-ray generator an amount of φ is expressed in length φ×p₀/2π=(b_{y}−a)/M_{y}×p₀ when the radiation-source grating is used. Here, p₀ is a pitch of the radiation-source grating. In the Talbot interferometer, p₀=p₂×L1/(L2−L1), and thus, (b_{y}−a)/M_{y}×p₀=(b_{y}−a)×p₂×L1/{M_{y}×(L2−L1)}. When the radiation-source grating is not used, the moiré pattern can be shifted an amount of φ by shifting the X-ray generator (b_{y}−a)×p₂×L1/{M_{y}×(L2−L1)}. Here, p₂ is a pitch of the shield grating.

The amount of shift of the diffraction grating projected over the detection range of the detector (also simply referred to as a diffraction grating on the detector, below) is equal to the amount of shift of the position of the moiré pattern on the detector. Thus, when the diffraction grating on the detector is shifted (b_{y}−a)×d_{y} in the y direction while the X-ray generator and the analyzer grating are fixed, the position of the moiré pattern on the detector is shifted (b_{y}−a)×d_{y} in the y direction. When this shift is expressed in phase, in order to shift the phase of the moiré pattern an amount of φ, the phase of the diffraction grating may be shifted an amount of φ/2 when the diffraction grating is a π grating, whereas the phase of the diffraction grating may be shifted an amount of φ when the diffraction grating is a π/2 grating. When the distance required to shift the phase of the diffraction grating an amount of φ/2 is expressed in length, φ/2×p₁/2π=(b_{y}−a)/M_{y}×p₁/2. When the distance required to shift the phase of the diffraction grating an amount of φ is converted into length, φ×p₁/2π=(b_{y}−a)/M_{y}×p₁. Here, p₁ denotes a pitch of the diffraction grating.

The amount of shift of the shield grating projected over the detection range of the detector (also simply referred to as a shield grating on the detector, below) is equal to the amount of shift of the position of the moiré pattern on the detector. Thus, when the shield grating on the detector is shifted (b_{y}−a)×d_{y} in the y direction while the X-ray generator and the diffraction grating are fixed, the position on the detector at which a moiré pattern is formed is shifted (b_{y}−a)×d_{y} in the y direction. When this shift is expressed in phase, in order to shift the phase of the moiré pattern an amount of φ, the phase of the shield grating may be shifted an amount of φ. When the distance required to shift the phase of the shield grating an amount of φ is converted into length, φ×p₂/2π=(b_{y}−a)/M_{y}×p₂. Here, p₂ is a pitch of the shield grating.

In order to shift the relative positions of the measurable range and the object, at least one of the measurable range and the object may be shifted. In the case where the measurable range is shifted by shifting the position of the moiré pattern, the amount of shift of the above-described components (the X-ray generator, the diffraction grating, and the shield grating) can be calculated using the relationship between the amount of shift of each components and the amount of shift of the moiré pattern. In the case where the measurable range is shifted by shifting the detector, the amount of shift of the detector is equal to the amount of shift of the measurable range. In the case where the measurable range and the object are shifted relative to each other by shifting the object, the amount of shift of the object is equal to the amount by which the measurable range and the object are shifted relative to each other. Thus, the amount of shift of each component can be calculated using these relationships.

Referring now to FIGS. 1A to 1E, specific descriptions are given below.

Referring to FIG. 1A, first, a form in which an object is scanned by shifting the detector is described. The scanning unit shifts the relative positions of the object and the detector d_{y}×(n_{y}−a) in the y direction by shifting the detector d_{y}×(n_{y}−a) in the y direction. Here, the amount of shift of the relative positions of the position of the moiré pattern and the detector in the y direction has to satisfy (b_{y}−a)×d_{y}+M_{y}×d_{y}×n. When (b_{y}−a)×d_{y}+M_{y}×d_{y}×n is converted into radian units, it is expressed as φ+2nπ. Here, the cycle of the moiré pattern M_{y}×d_{y} is assumed as 2π. Thus, the moiré pattern may be shifted so that the amount of shift of the relative positions of the position of the moiré pattern and the detector satisfies φ+2nπ using the relationship between the amount of shift of the moiré pattern and the amount of shift of the above-described components (the X-ray generator, the radiation-source grating, the diffraction grating, and the shield grating). When b_{y}=a=0, the detector may be shifted d_{y}×n_{y} while the position of the moiré pattern and the position of the object are fixed. This is because such a shift moves the position of the moiré pattern and the position of the detector an amount of d_{y}×n_{y} and thus the shift in the y direction between the position of the moiré pattern and the position of the detector satisfy M_{y}×d_{y}×n whatever value d_{y}×n_{y} takes.

Referring now to FIG. 1B, a form in which an object is scanned by shifting the shield grating is described. The scanning unit shifts the relative positions of the object and the measurable range an amount of d_{y}×(n_{y}−a) by shifting the position of the shield grating on the detector an amount of d_{y}×(n_{y}−a). Here, the amount of shift of the relative positions of the position of the moiré pattern and the detector has to satisfy (b_{y}−a)×d_{y}+M_{y}×d_{y}×n. As described above, when (b_{y}−a)×d_{y}+M_{y}×d_{y}×n is converted into radian units, it is expressed as φ+2nπ. Thus, the moiré pattern may be shifted so that the amount of shift of the relative positions of the position of the moiré pattern and the detector satisfies φ+2nπ using the relationship between the amount of shift of the moiré pattern and the amount of shift of the above-described components. When the amount of shift of the relative positions of the position of the moiré pattern and the detector as a result of shift of the shield grating is (b_{y}−a)×d_{y}+M_{y}×d_{y}×n, the positions of the object, the detector, and the interference pattern may remain fixed. In other words, when d_{y}×(n_{y}−a)=(b_{y}−a)×d_{y}+M_{y}×d_{y}×n, the amount of shift of the relative positions of the position of the moiré pattern and the detector is (b_{y}−a)×d_{y}+M_{y}×d_{y}×n when the position of the moiré pattern is shifted d_{y}×(n_{y}−a) by shifting the shield grating while the detection range, the object, and the interference pattern are fixed. Since n_{y} is a positive integer multiple of M_{y}, when b_{y}=0, d_{y}×(n_{y}−a)=(b_{y}−a)×d_{y}+M_{y}×d_{y}×n whatever value a takes. Thus, the first pattern and the second pattern have continuity when the relative positions of the shield grating and the object are shifted a distance obtained by multiplying the pitch of the shield grating by an integer of one or larger. Here, instead of fixing the interference pattern, the interference pattern may be shifted a distance obtained by multiplying the cycle of the interference pattern by an integer.

Referring now to FIG. 1C, a form in which the object is scanned by shifting the diffraction grating is described. The scanning unit shifts the relative positions of the object and the measurable range d_{y}×(n_{y}−a) by shifting the position of the diffraction grating on the detector d_{y}×(n_{y}−a). Here, the amount of shift of the relative positions of the position of the moiré pattern and the detection range of the detector has to satisfy (b_{y}−a)×d_{y}+M_{y}×d_{y}×n. When (b_{y}−a)×d_{y}+M_{y}×d_{y}×n is converted into radian units, it is expressed as φ+2nπ. Thus, the moiré pattern may be shifted so that the amount of shift of the relative positions of the position of the moiré pattern and the detector satisfies φ+2nπ using the relationship between the amount of shift of the moiré pattern and the amount of shift of the above-described components. When the amount of shift of the relative positions of the position of the moiré pattern and the detector as a result of shift of the diffraction grating is (b_{y}−a)×d_{y}+M_{y}×d_{y}×n, the positions of the object, the detector, the shield grating, and the X-ray generator (radiation-source grating) may remain fixed. In other words, when d_{y}×(n_{y}−a)=(b_{y}−a)×d_{y}+M_{y}×d_{y}×n, the amount of shift of the relative positions of the position of the moiré pattern and the detector is (b_{y}−a)×d_{y}+M_{y}×d_{y}×n when the position of the moiré pattern is shifted d_{y}×(n_{y}−a) by shifting the diffraction grating while the detection range, the object, and the shield grating remain fixed. Since n_{y} is a positive integer multiple of M_{y}, when b_{y}=0, d_{y}×(n_{y}−a)=(b_{y}−a)×d_{y}+M_{y}×d_{y}×n whatever value a takes. Thus, the first pattern and the second pattern have continuity when the diffraction grating is shifted a distance obtained by multiplying the pitch of the diffraction grating by an integer of one or larger.

Referring now to FIG. 1D, a form in which the object is scanned by shifting the radiation-source grating is described. The scanning unit shifts the relative positions of the object and the measurable range d_{y}×(n_{y}−a) by shifting the position of the radiation-source grating on the detector d_{y}×(n_{y}−a). Here, the amount of shift of the relative positions of the position of the moiré pattern and the detection range of the detector has to satisfy (b_{y}−a)×d_{y}+M_{y}×d_{y}×n. When (b_{y}−a)×d_{y}+M_{y}×d_{y}×n is converted into radian units, it is expressed as φ+2nπ. Thus, the moiré pattern may be shifted so that the amount of shift of the relative positions of the position of the moiré pattern and the detector satisfies φ+2nπ using the relationship between the amount of shift of the moiré pattern and the amount of shift of the above-described components. When the amount of shift of the relative positions of the position of the moiré pattern and the detector as a result of shift of the radiation-source grating is (b_{y}−a)×d_{y}+M_{y}×d_{y}×n, the positions of the object, the detector, and the shield grating may remain fixed. In other words, when d_{y}×(n_{y}−a)=(b_{y}−a)×d_{y}+M_{y}×d_{y}×n, the amount of shift of the relative positions of the position of the moiré pattern and the detector is (b_{y}−a)×d_{y}+M_{y}×d_{y}×n when the position of the moiré pattern is shifted d_{y}×(n_{y}−a) by shifting the diffraction grating while the detection range, the object, and the shield grating are fixed. Since n_{y} is a positive integer multiple of M_{y}, when b_{y}=0, d_{y}×(n_{y}−a)=(b_{y}−a)×d_{y}+M_{y}×d_{y}×n whatever value a takes. Thus, the first pattern and the second pattern have continuity when the radiation-source grating is shifted a distance obtained by multiplying the pitch of the radiation-source grating by an integer of one or larger.

Referring now to FIG. 1E, a form in which the object is scanned by shifting the object (object stand) is described. The scanning unit shifts the relative positions of the object and the measurable range d_{y}×(n_{y}−a) by shifting the position of the object projected over the detection range of the detector (also simply referred to as the position of the object on the detector, below) d_{y}×(n_{y}−a). Here, the amount of shift of the relative positions of the position of the moiré pattern and the detection range of the detector has to satisfy (b_{y}−a)×d_{y}+M_{y}×d_{y}×n. When (b_{y}−a)×d_{y}+M_{y}×d_{y}×n is converted into radian units, it is expressed as φ+2nπ. Thus, the moiré pattern may be shifted so that the amount of shift of the relative positions of the position of the moiré pattern and the detector satisfies φ+2nπ using the relationship between the amount of shift of the moiré pattern and the amount of shift of the above-described components. When the measurement range is shifted a distance of z in accordance with the shift of the relative positions of the position of the moiré pattern and the detection range, the relative positions of the object and the measurement range may be shifted d_{y}×(n_{y}−a) by shifting the object d_{y}×(n_{y}−a)+z. When (b_{y}−a)×d_{y}+M_{y}×d_{y}×n is zero, the scanning unit 11 may shift the object while the position of the moiré pattern and the detection range are fixed.

It is preferable that the positioning error of the scanning unit be small. Specifically, the displacement between the first detection result pattern and the second detection result pattern preferably falls within 10% the cycle of the pattern (moiré pattern). To this end, the phase shift of the moiré pattern due to the error may fall within ⅕π. In other words, the positioning error is preferably within 10% the pitch of the cycle of the grating when the grating is shifted or preferably within 10% the pixel size of the detector when the detector or the object is shifted. The positioning error may be within 10% the X-ray generator when the X-ray generator is shifted. For example, when the relative positions of a measurable range and an object are shifted d_{y}×(n_{y}−a) in the y direction, the actual amount of shift may be (n_{y}−a)×d_{y}−0.1d_{y} or larger and (n_{y}−a)×d_{y}+0.1d_{y} or smaller. When the relative positions of the second pattern and the detection range are shifted (b_{y}−a)×d_{y} in the y direction, the actual amount of shift may be (b_{y}−a)×d_{y}−0.1M_{y}×d_{y} or larger and (b_{y}−a)×d_{y}+0.1M_{y}×d_{y} or smaller. When the relative positions of the shield grating and the object are shifted a distance (referred to as L4) obtained by multiplying the pitch of the shield grating by an integer of one or larger, the actual amount of shift may be a length that is not below a length obtained by subtracting 10% the cycle of the shield grating from L4 but that is not above a length obtained by adding 10% the cycle of the shield grating to L4. In addition, when the relative positions of the phase grating and the object are shifted a distance (referred to as L5) obtained by multiplying the pitch of the phase grating by an integer of one or larger, the actual amount of shift may be a length that is not below a length obtained by subtracting 10% the cycle of the phase grating from L5 but that is not above a length obtained by adding 10% the cycle of the phase grating to L5.

The computation unit 6 is connected to the detector 4 and computes object information on the basis of information on the detection results of the detector. In this description, acquiring object information by referring to a table is also defined as computing object information. The computation unit may be any unit that can compute object information and a central processing unit (CPU) may be used as an example of the computation unit. The CPU is connected to a storage portion such as a random access memory (RAM) and performs operations of arithmetic.

When a is one or larger, a computation unit 6 according to some embodiments computes information on the synthesized-X-rays' intensity distribution by splicing information pieces of multiple detection results together in order to reduce time taken to acquire object information by the time corresponding to overlapping portions of the first detection result and the second detection result. Specifically, the synthesized-X-rays' intensity distribution is computed by splicing the first detection result pattern and the second detection result pattern together. The computation unit also performs phase retrieval using the information on the synthesized-X-rays' intensity distribution to compute information on the differential phase image of the object. If object information is computed from each of the first detection result and the second detection result, the object information for the overlapping portions is computed twice. On the other hand, if object information is computed from the information on the synthesized-X-rays' intensity distribution, the object information for the overlapping portions is computed only once. Thus, the time taken to acquire the object information can be reduced. The phase retrieval method is not particularly limited. Usable examples of the phase retrieval include the Fourier transform, fringe scanning, and an intermediate between the Fourier transform and fringe scanning.

In addition, the accuracy of object information at the edges can be improved by calculating the above-described synthesized-X-rays' intensity distribution. Here, in order to improve the accuracy of the object information at the edges, object information may be acquired using the synthesized-X-rays' intensity distribution obtained by splicing one detection result and a part of or the entirety of another detection result together. Specifically, by computing object information on the basis of the synthesized-X-rays' intensity distribution obtained by splicing one detection result and a part of or the entirety of another detection result together, the accuracy of object information at the edges can be improved. In the case where only a part of the second detection result is spliced to the first detection result, the part of the second detection result that is to be spliced to the first detection result preferably includes a portion at which object information for a region that is the closest, in terms of distance, to the object information acquired from the first detection result is acquired. For example, in the case where a first detection result is acquired and a second detection result is then acquired by shifting the measurable range to the right using the scanning unit, a portion of the second detection result that is to be spliced to the first detection result preferably includes the left edge of the second detection result. However, in the case where the phase shift of the object is small, the accuracy can be improved even though the portion that is spliced does not include the portion (left edge) at which object information for the region closest in terms of distance is acquired. Use of this splicing method enables improvement in accuracy of object information at the edges regardless of the value of a.

In the case where a is one or larger, the first detection result pattern and the second detection result pattern partially overlap with each other. In this case, a detection result of either one of the overlapping portions may be used or the mean of the detection results of the overlapping portions may be used as a detection result of the overlapping portions. Alternatively, information pieces of the overlapping portions may be added together so that an S/N ratio of the overlapping portions is improved.

The information on the phase image may be computed by integrating the information on the acquired differential phase images. In the case where the information on the differential phase images or the phase images of the object are not required, information such as dispersion images or absorption images may be computed without performing phase retrieval. When such information is computed as object information, the time taken for computation may be reduced or the accuracy of the object information may be improved by using the synthesized-X-rays' intensity distribution. A dispersion image is an image representing the change in amplitude of X-rays due to the object. The synthesized-X-rays' intensity distribution may be synthesized on the basis of information on multiple detection results and the number of detection results to be synthesized is not particularly limited.

An object information display unit 15 is a monitor that can display object information. For example, a cathode ray tube (CRT), a liquid crystal display (LCD), or the like can be used as the object information display unit 15. The object information display unit 15 is connected to the computation unit 6 and can display computation results of object information computed by the computation unit. A printer may also be used instead of a monitor. In other words, the object information display unit may be any unit that can display object information. Here, the object information is not limited to images. For example, coordinates in the entire measurable range and numerical values of the object information in the coordinates (for example, phase values or X-ray intensity) may be displayed.

### Second Embodiment

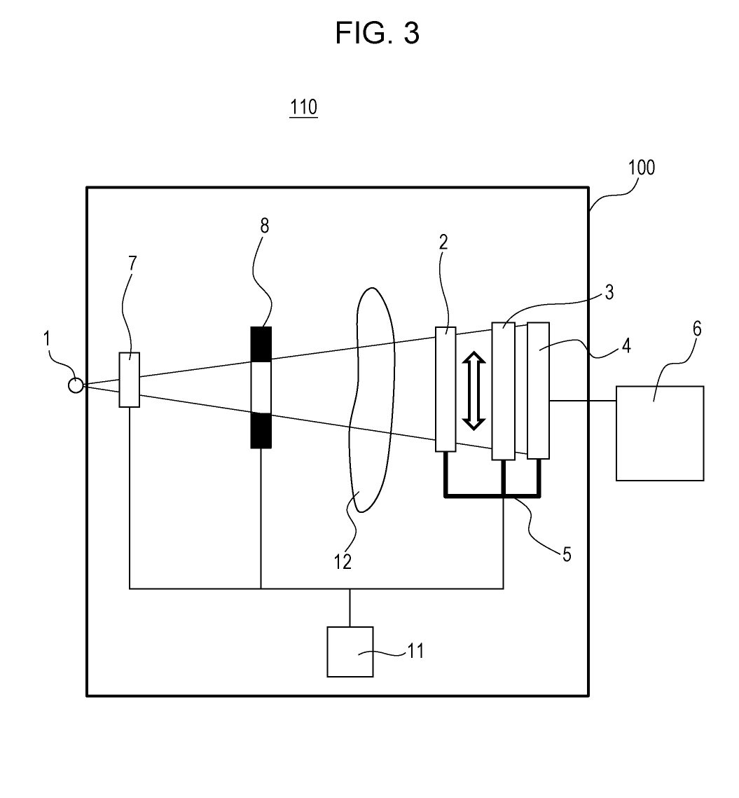

In a second embodiment, an interferometer that scans an object by shifting, as an integrated unit, the diffraction grating, the shield grating, and the detector is described. FIG. 3 illustrates an example of the configuration of the interferometer according to the second embodiment.

Similarly to the interferometer 110 according to the first embodiment, an interferometer 120 includes a radiation-source grating 7, a diffraction grating 2, a shield grating 3, a detector 4, and a scanning unit 11. The interferometer 120 also includes a fastening unit 5 and a collimator 8. The fastening unit 5 fastens the diffraction grating, the shield grating, and the detector together as an integrated unit. The collimator 8 delimits the range of the object irradiated with X-rays.

The collimator 8 has a structure in which a screening portion surrounds one opening to delimit the range of the object irradiated with X-rays. This structure can prevent a region of the object outside the measurable range (a region of the object that is not projected within the measurable range when the object is projected on the detector) from being irradiated with X-rays. However, if delimitation of the range of the object irradiated with X-rays is not necessary as in the case where the entirety of the object is irradiated with X-rays, the collimator 8 is not required.

The fastening unit 5 has such a structure as to fasten the diffraction grating 2, the shield grating 3, and the detector 4 together as an integrated unit. For example, the fastening unit 5 is a holding unit that holds the diffraction grating 2, the shield grating 3, and the detector 4 together as an integrated unit. In this embodiment, the diffraction grating is shifted together with the shield grating. This configuration enables size reduction of the grid region of the diffraction grating 2 to the size smaller than or equal to the size of the grid region of the shield grating 3 (may be smaller than the grid region of the shield grating by the area corresponding to the magnification). In addition, together with the diffraction grating 2 and the shield grating 3, the detector 4 is shifted with respect to the object. The detection range of the detector is required to be sized larger than the grid region of the shield grating by the area corresponding to the magnification. However, since the distance between the shield grating and the detector is usually small, the detection range of the detector may be sized approximately the same as the grid region of the shield grating 3.

Fabricating the shield grating 3 is usually more difficult than fabricating the diffraction grating or the detector. Thus, it is preferable to use the following diffraction grating 2 and the following detector 4: the diffraction grating 2 sized so as to form an interference pattern over the entire grid region of the shield grating 3; and the detector 4 having a detection range within which the entire X-rays that have passed through the shield grating 3 can be detected. Hereinbelow, the integrated unit of the diffraction grating 2, the shield grating 3, and the detector 4 may be referred to as a gridded detector.

The scanning unit 11 shifts the gridded detector. The scanning unit 11 can also shift the radiation-source grating 7 and the collimator 8 in synchronization with the shift of the gridded detector. The scanning unit according to the second embodiment can also have an instructing unit and an actuator. The actuator shifts the gridded detector on the basis of an instruction from the instructing unit. In the case of shifting the radiation-source grating 7 and the collimator 8, the scanning unit also includes an actuator for shifting the radiation-source grating and an actuator for shifting the collimator. An instructing unit that transmits an instruction to the actuator for shifting the radiation-source grating and the collimator may be the same as or different from an instructing unit that transmits an instruction to the actuator for shifting the gridded detector.

In this embodiment, in the case where the radiation-source grating is not shifted, the position of the moiré pattern and the detector are not shifted relative to each other. Thus, the amount by which the position of the moiré pattern and the detector are shifted relative to each other has to satisfy (b_{y}−a)×d_{y}+M_{y}×d_{y}×n=M_{y}×d_{y}×n₁ (that is, the amount by which the position of the moiré pattern and the detector are shifted relative to each other is an integer multiple of the cycle of the moiré pattern). To this end, for example, the condition b_{y}=a=0 may be satisfied. Specifically, at least one of a selection of the detector and an adjustment of the cycle of the moiré pattern may be performed so that n_{y} is divisible by M and the gridded detector may be shifted so that the measurable range is shifted n_{y}×d_{y} in the y direction while the object is fixed. Consequently, b_{y}=a=0 and the amount of shift of the detection range is d_{y}×(n_{y}−a) (here, a=0). Although b_{y}=a=0 is not satisfied, (b_{y}−a)×d_{y}=0 provided that b_{y}=a. Specifically, the gridded detector may be shifted so that the number of pixels (a) in the first detection result and the second detection result that overlap with other is equal to the remainder (b_{y}) obtained when n_{y} is divided by M_{y}. Even when the radiation-source grating is shifted, the position of the moiré pattern and the detection range are not shifted relative to each other if the radiation-source grating is shifted a distance equivalent to an integer multiple of the cycle of the radiation-source grating between the time at which the first detection result is acquired and the time at which the second detection result is acquired. Thus, the gridded detector may be shifted similarly as in the case where the radiation-source grating is not shifted. In the case where the radiation-source grating is shifted so that the position of the moiré pattern and the detection range are shifted relative to each other, the gridded detector and the radiation-source grating may be shifted in synchronization with each other so that the amount by which the position of the moiré pattern and the position of the detection range are shifted relative to each other is (b_{y}−a)×d_{y}+M_{y}×d_{y}×n and the amount of shift of the detection range is d_{y}×(n_{y}−a).

FIG. 3 illustrates an example of the direction of shift of the gridded detector performed by the scanning unit 11, the direction being represented by an arrow. However, the direction of shift of the gridded detector may be any direction as long as the relative positions of a measurable range and an object can be shifted in that direction. For example, when a diffraction grating and a shield grating having cycles in the X direction and Y direction that are perpendicular to each other are used, the gridded detector may be shifted along the X axis or Y axis or may be shifted along the XY plane.

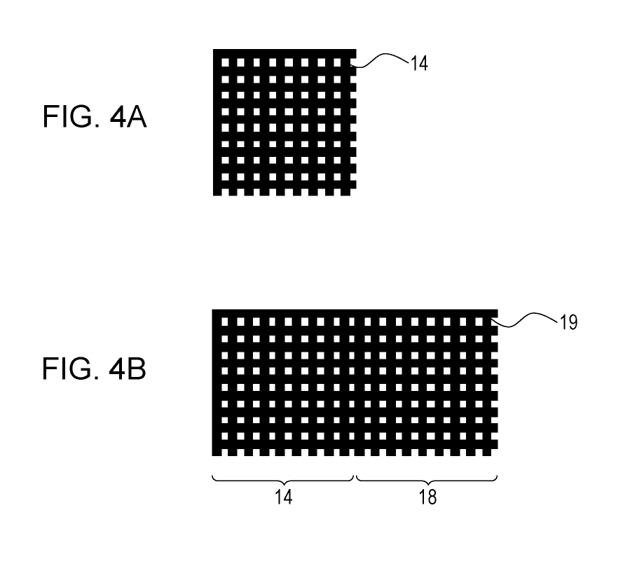

Referring to FIGS. 4A and 4B, a first detection result pattern and a second detection result pattern acquired by an interferometer according to some embodiments will be described. Description is given on the assumption that, when the object and the measurable range take first relative positions, the gridded detector and the object also take first relative positions, whereas, when the object and the measurable range take second relative positions, the gridded detector and the object also take second relative positions.

FIG. 4A illustrates a first detection result pattern 14. Provided that b_{y}=a=0, a synthesized-X-rays' intensity distribution 19 illustrated in FIG. 4B is acquired by splicing together the first detection result pattern 14 and the second detection result pattern 18, the second detection result pattern 18 being acquired by shifting the gridded detector a cycle of d_{y}×n_{y} after acquiring the first detection result. As viewed in FIG. 4B, the first synthesized-X-rays' intensity distribution 19 is such an intensity distribution that the intensity distribution of the first detection result pattern 14 is elongated in the lateral direction of the drawing while keeping its original cycle. It is found that the cycle at the splice is the same as the cycles at the other portions. It is thus found that the first and second detection result patterns have continuity.

In this manner, even when the scanning unit shifts the gridded detector so that the first and second detection result patterns have continuity, the amount of shift of the relative positions in directions other than the direction of the cycle of the diffraction grating and the direction of the cycle of the shield grating is not concerned. Specifically, in the case, for example, where the diffraction grating and the shield grating have a one-dimensional cyclic structure and the direction of the cycle of the shield grating and the direction of the cycle of the diffraction grating coincide with each other, the amount of shift from the first relative positions to the second relative positions may be any distance in the direction perpendicular to the directions of the cycles of the shield grating and the diffraction grating. In the case where the direction of the cycle of the shield grating is different from the direction of the cycle of the diffraction grating, the amount of shift of the shield grating may be any distance in the direction perpendicular to the direction of the cycle of the shield grating and the amount of shift of the diffraction grating may be any distance in the direction perpendicular to the direction of the cycle of the diffraction grating.

In the synthesized-X-rays' intensity distribution illustrated in FIG. 4B, the first detection result pattern and the second detection result pattern have the same cycle. In this manner, it is preferable to acquire a synthesized-X-rays'intensity distribution from information pieces of patterns having the same cycles.

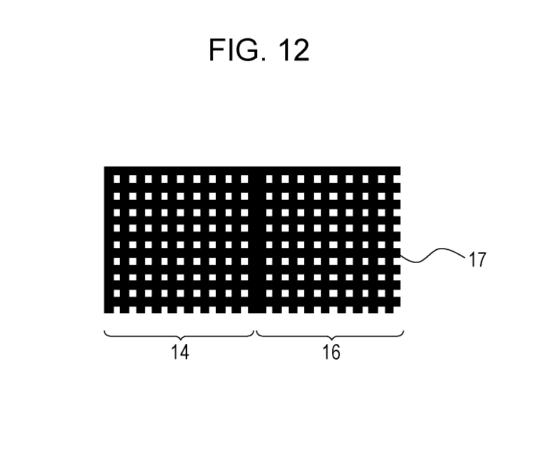

Referring now to FIG. 12, an example is described in which a synthesized-X-rays' intensity distribution is acquired from patterns that do not have continuity. After the first detection result is detected, detection is performed by shifting the gridded detector in such a manner that the shield grating on the detector shifts a distance that is a positive integer multiple of the cycle of the shield grating+½ the cycle. When the detection result pattern acquired from this detection and the first detection result pattern are spliced together, the synthesized-X-rays' intensity distribution 17 illustrated in FIG. 12 is acquired. As viewed in FIG. 12, the cycle at the splice between the two detection result patterns 14 and 16 is different from the cycle of the other portions. It is thus found that this synthesized-X-rays' intensity distribution is acquired by synthesizing patterns that do not have continuity. When the cycle at the splice and the cycle at other portions are different from each other and do not have continuity, object information acquired from phase retrieval of the synthesized-X-rays' intensity distribution 17 may have an error or the phase retrieval itself may become difficult to perform.

The positioning error that occurs when the scanning unit positions the gridded detector may be within 10% the moiré pattern cycle. The positioning can thus be easily controlled compared to that case where the relative positions of the object and the measurable range are shifted by shifting only the detector, only the shield grating, only the diffraction grating, or only the radiation-source grating.

In order to prevent unmeasurable range of the object from being produced, the relative positions of the gridded detector and the object have to be shifted, when the relative positions are shifted from the first relative positions to the second relative positions, within the measurable range measured by the gridded detector. Specifically, when the dimension of the measurable range measured by the gridded detector in the y direction is defined as Y (Y=n_{y}×d_{y}), the amount of shift from the first relative positions to the second relative positions may only have to be Y or smaller in the y direction (that is, a is zero or larger).

In the case where an unmeasurable range is allowed to be produced, the first detection result and the second detection result do not have to be in contact with each other. Thus, the amount of shift from the first relative positions to the second relative positions may be larger than Y in the y direction (that is, a may be minus one or smaller). In this case, the first detection result and the second detection result are spliced together with a blank space interposed therebetween. An X-rays' intensity distribution acquired by splicing the results together in this manner is also referred to as a synthesized-X-rays' intensity distribution.

In the synthesized-X-rays' intensity distribution illustrated in FIG. 4B, the first detection result and the second detection result are in contact with each other at their edges. However, the first detection result and the second detection result may overlap with other. If the above-described a is an integer of one or larger, the first detection result and the second detection result overlap with other. When the first detection result and the second detection result overlap with each other in the synthesized-X-rays' intensity distribution, the overlapping portions have a high S/N ratio, whereby object information having less noise than information at other portions can be acquired. In order to have a noise reduction effect, it is preferable that the amount of shift from the first relative positions to the second relative positions in the y direction be smaller than 9Y/10 where the dimension of the measurable range in the y direction is defined as Y. The amount is more preferably larger than 2y/5 and, yet more preferably, larger than y/2.

On the other hand, in order to acquire a largest possible measurable range with the same number of times of detection, the overlapping portions may be contracted or eliminated. To this end, the amount of shift from the first relative positions to the second relative positions may be determined in consideration of the size of the measurable range, the number of times of detection, and the noise reduction effect at the overlapping portions. In order to contract the overlapping portions, the amount of shift may be increased. Thus, in order to acquire a large measurable range, an increase in amount of shift from the first relative positions to the second relative positions is preferable. As described above, when the dimension of the measurable range in the y direction is Y, it is preferable that the amount of shift from the first relative positions to the second relative positions be Y/2 or larger in the y direction. The amount is more preferably 3y/4 or larger and, yet more preferably, 9y/10 or larger.

The cycle diffraction grating and the shield grating may be curved while having the X-ray generator at the center. In this case, it is preferable that the diffraction grating and the shield grating shift along the surface of a sphere having the X-ray generator at the center. Even when a flat shield grating and a flat diffraction grating are used, if the shield grating and the diffraction grating are shifted along the surface of the sphere having the X-ray generator at the center, emitted X-ray vignetting due to the shield grating can be reduced. The X-ray vignetting here means that X-rays that are supposed to pass through are blocked by the screening portions 13 as the incident angle of the X-rays with respect to the shield grating 3 approaches the horizon.

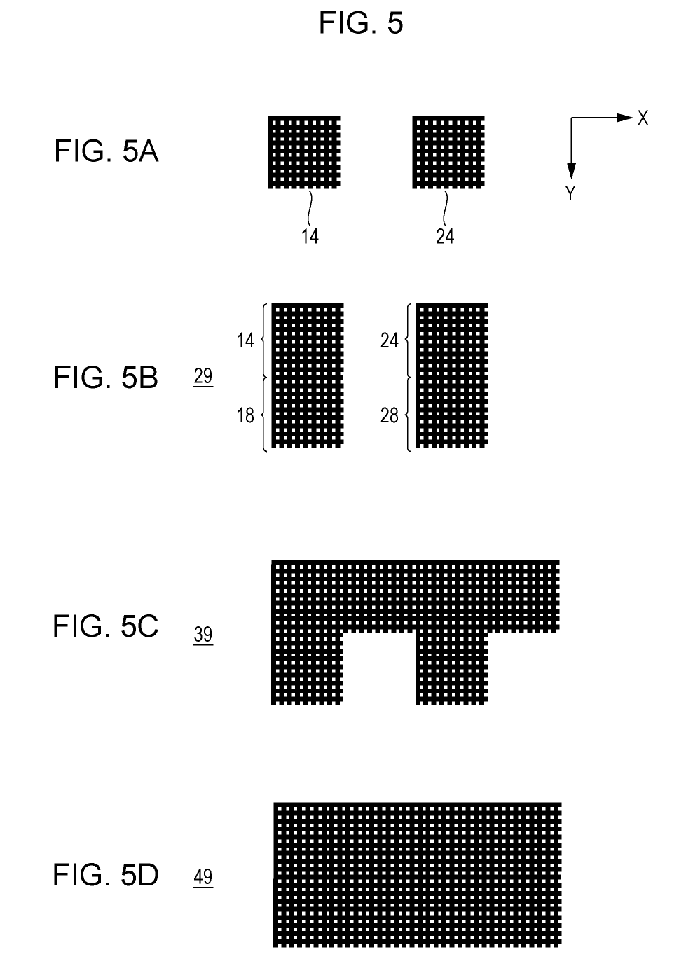

In addition, use of multiple gridded detectors enables reduction of measurement time. FIGS. 5A to 5D illustrates detection results obtained from four times of detection performed by a first gridded detector and a second gridded detector. FIG. 5A illustrates a first detection result 14 obtained by the first gridded detector and a first detection result 24 obtained by the second gridded detector. Second detection results 18 and 28 are obtained after shifting the first and second gridded detectors in the y direction and are then spliced to the first detection results 14 and 24 to compute a synthesized-X-rays' intensity distribution 29 (FIG. 5B). After the first and second gridded detectors are returned to the original positions, the first and second gridded detectors are shifted in the x direction to acquire third detection results. The third detection results are also spliced to the synthesized-X-rays' intensity distribution 29 illustrated in FIG. 5B to compute a synthesized-X-rays' intensity distribution 39 (FIG. 5C). Subsequently, the first and second gridded detectors are shifted in the y direction to acquire fourth detection results. The fourth detection results are also spliced to the synthesized-X-rays' intensity distribution 39 illustrated in FIG. 5C to acquire a synthesized-X-rays' intensity distribution 49 (FIG. 5D). In the case where multiple gridded detectors are used in the above case, it is preferable that the detection result patterns obtained by the first gridded detector and the detection result patterns obtained by the second gridded detector be arranged so as to have continuity. To this end, it is preferable that the first gridded detector and the second gridded detector be arranged so as to be apart from each other at a distance that is an integer multiple of the cycle of the shield grating on each detector. In such an arrangement, the cycle at the splice between the detection result of the first gridded detector and the detection result of the second gridded detector are the same as the cycle at the other portions.

As illustrated in the first embodiment, even in the structure where the object and the measurable range are shifted relative to each other by shifting only one of the radiation-source grating, the diffraction grating, the shield grating, and the detector, if the structure only includes components that are to be shifted (for example, shield gratings), the measurement time can be reduced.

### Third Embodiment

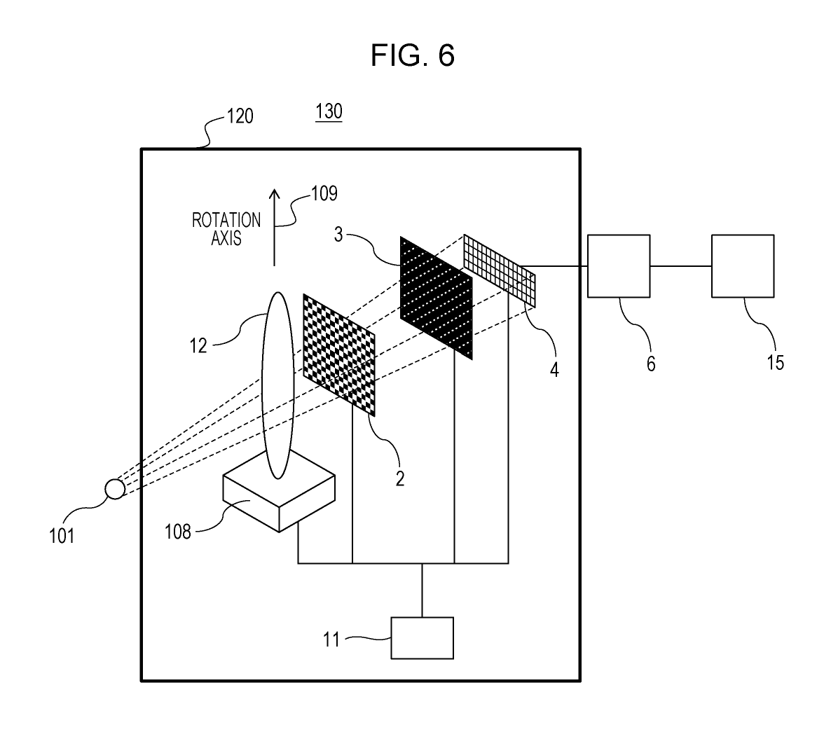

In the third embodiment, an X-ray CT scanner using Talbot interference is described. An X-ray CT scanner according to some embodiments is one of the variations of the interferometer. FIG. 6 schematically illustrates an X-ray CT scanner according to the third embodiment. An X-ray CT scanner 120 includes an object stand 108, a diffraction grating 2, which diffracts X-rays from an X-ray generator 101, a shield grating 3, which blocks some of X-rays, and a detector 4, which detects X-rays that have passed through the shield grating. As in the case of the interferometer according to the first embodiment, the X-ray CT scanner, a computation unit 6, which computes the detection results of the detector of the X-ray CT scanner, a display unit 15, which displays images on the basis of computation results of the computation unit, and the X-ray generator 101 constitute an X-ray CT system 130. The X-ray CT scanner also includes a scanning unit 11 that shifts the object and the measurable range relative to each other in the direction of a rotation axis 109. In this embodiment, the scanning unit 11 rotates the object stand 108 around the rotation axis 109.

Each component will be briefly described, but the components that are the same as those in the first embodiment will not be described.

In this embodiment, the focus (X-ray generating area) of the X-ray generator 101 that irradiates the diffraction grating with X-rays is small and thus the X-rays can be diffracted by the diffraction grating 2 without using a radiation-source grating so that an interference pattern can be formed. Thus, the X-ray CT scanner 120 according to this embodiment does not include a radiation-source grating. However, depending on an X-ray generator to be used, a radiation-source grating may be included. In other words, as in the cases of the first and second embodiments, the third embodiment is also applicable to a Talbot interferometer or a Talbot-Lau interferometer.

As in the cases of the first and second embodiments, the scanning unit 11 according to the third embodiment can include, for example, an instructing unit, which instructs an amount of shift of each component, and an actuator, which shifts each component on the basis of the instruction of the instructing unit. The X-ray CT scanner can perform computed tomography with a rotation of an object due to the scanning unit 11 rotating the object stand 108. The computed tomography is not limited to measurement for acquiring images on the basis of object information acquired by the CT scanner and may be measurement for acquiring, for example, numerical object information. Here, instead of performing computed tomography with a rotation of an object, computed tomography may be performed with rotations of the X-ray generator, the diffraction grating, the shield grating, and the detector with respect to the rotation axis. In this case, the X-ray CT scanner may exclude an object stand since the X-ray generator, the diffraction grating, the shield grating, and the detector rotate around the object disposed at an appropriate position.

The computation unit computes tomogram information on the object using detection result patterns obtained by measuring the object from multiple angles. The computation of tomogram information on the object involves computation of information on at least one of the mean intensity, the mean amplitude, and the mean phase of the detection result patterns (moiré patterns) for each detection result and reconstruction performed by, for example, a typical CT scanner.

Although the display unit according to this embodiment displays images based on the computation results of the computation unit, the display unit is not limited to the one that displays images. For example, instead of images, the display unit may display numerical computation results of the computation unit. Here, the X-ray CT system is also one of object information acquisition systems.

A tomography performed by the X-ray CT scanner according to this embodiment will be described now. The X-ray CT scanner according to this embodiment measures an object by helical scanning. In other words, an X-ray CT scanner 120 performs measurement while rotating an object and concurrently shifting the object and the measurable range relative to each other in the direction of the rotation axis. When the helical scanning measurement is performed, detection result patterns obtained from projection of the object from equal angles and having different relative positions of the object and the measurable range with respect to the direction of the rotation axis are regarded as a first detection result pattern and a second detection result pattern. Thus, the scanning unit 11 shifts each component so that the first and second detection result patterns have continuity. If detection is performed N times per rotation, the detector performs detection once per rotation at 360/N degrees. Since the measurement is performed by helical scanning, the relative positions of the object and the measurable range are shifted d_{y}×(n_{y}−a)/N per detection in the direction of the rotation axis. At this time, the moiré pattern and the detector are shifted (b_{y}−a)×d/N per detection. In other words, when helical scanning measurement is performed, the amount by which the object and the measurable range are shifted relative to each other per detection and the amount by which the moiré pattern and the detection range are shifted relative to each other per detection both become 1/N with respect to those in the first embodiment. Thus, every time an object makes one rotation, the relative positions of the object and the measurable range in the direction of the rotation axis are shifted d_{y}×(n_{y}−a) and the relative positions of the moiré pattern and the detection range in the direction of the rotation axis are shifted (b_{y}−a)×d_{y}.

In the case where the X-ray CT scanner performs nonhelical scanning, the scanning unit 11 shifts each component so that detection result patterns obtained from projection of the object from equal angles and having different relative positions of the object and the measurable range with respect to the direction of the rotation axis have continuity.

If detection is performed N times per rotation, the detector performs detection per rotation at 360/N degrees. The relative positions of the object and the measurable range are shifted d_{y}×(n_{y}−a) per detection in the direction of the rotation axis. The relative positions of the moiré pattern and the detection range in the direction of the rotation axis may be shifted a distance (b_{y}−a)×d_{y} in total per rotation. The moiré pattern and the detection range may be shifted relative to each other per detection or may be shifted per rotation.

In the case of using a CT scanner that acquires CT images (tomograms) by helical scanning using detection results detected at the projection angle ranging from 0 to 180 degrees, the detector performs detection per rotation at 180/N degrees if it performs detection N times per half rotation. Thus, the relative positions of the object and the measurable range are shifted d_{y}×(n_{y}−a)/N in the direction of the rotation axis per detection. In the case of using a CT scanner that acquires CT images (tomograms) by nonhelical scanning using detection results detected at the projection angle ranging from 0 to 180 degrees, the detector performs detection per rotation at 180/N degrees if it performs detection N times per half rotation. Thus, the relative positions of the object and the measurable range are shifted d_{y}×(n_{y}−a) in the direction of the rotation axis per rotation.

As described above, whichever X-ray CT scanner that performs helical scanning or nonhelical scanning is used as an interferometer, the relative positions of the object and the measurable range and the relative positions of the moiré pattern and the detection range are shifted by the scanning unit between the first and second detections performed at the same angle. These relative positions are shifted in the same manner as in the case of the first embodiment. The relative positions of the object and the measurable range are shifted d_{y}×(n_{y}−a) in the direction of the rotation axis and the relative positions of the moiré pattern and the detection range are shifted (b_{y}−a)×d_{y} in the direction of the rotation axis.

In this embodiment, the object is discretely rotated the angles at which the object is measured. Specifically, the object (or the object stand) is repeatedly rotated and stopped and measured while being stopped. The object, however, may be continuously rotated and continuously measured while being rotated.

Hereinbelow, specific description is given using examples of the first to third embodiments and comparative examples.

### Example 1

Here, an example of the first embodiment is described. An interferometer of this example is an interferometer that shifts relative positions of the object and the measurable range as a result of the scanning unit 11 shifting the object stand 28 in the y direction. This interferometer has the structure illustrated in FIG. 1E. In this example, each of the radiation-source grating, the diffraction grating, and the shield grating has a two-dimensional cyclic structure that has cyclic structures in two directions and the second pattern (moiré pattern) thus formed has cycles in two directions, that is, the x direction and the y direction.

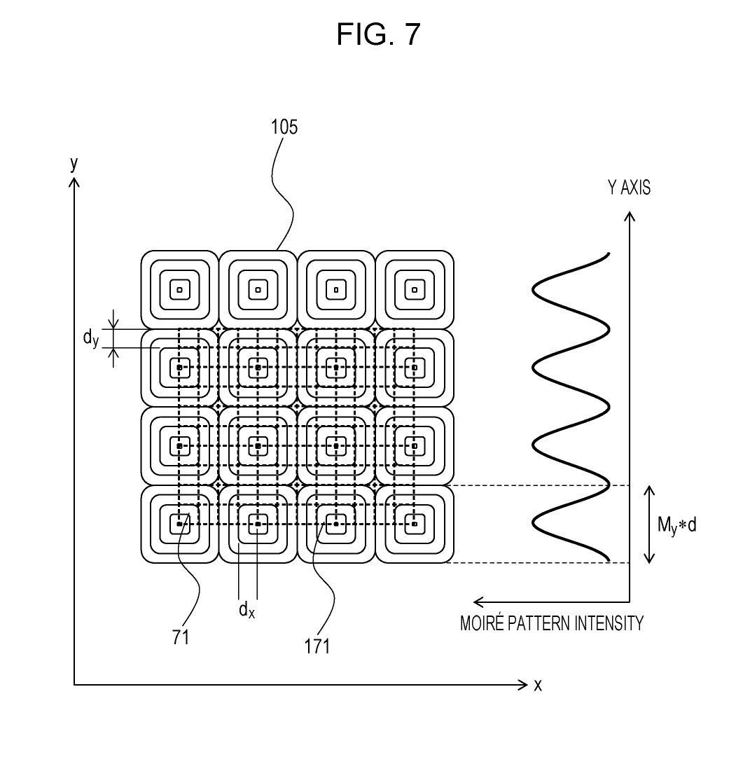

FIG. 7 illustrates a detection range 171 of the detector and a moiré pattern 105 on the detection range 171. In the detection range 171, detection pixels 71 each having a dimension in the x direction of dₓ and a dimension in the y direction of d_{y} are arranged in an array of nₓ, in the x direction, by n_{y}, in the y axis direction. The detection range is represented by dotted rectangles and the pixels are represented by squares delimited by solid lines in the detection range. The intensity distribution of the moiré pattern 105 is represented by the contour. In this example, the cycle of the moiré pattern 105 in the y direction is M_{y}×d_{y} where M_{y}=4. For ease of understanding, the intensity distribution in which the moiré pattern is integrated in the x direction is illustrated. In this embodiment, dₓ=d_{y} and the cycle of the moiré pattern 105 in the x direction is 4×dₓ.

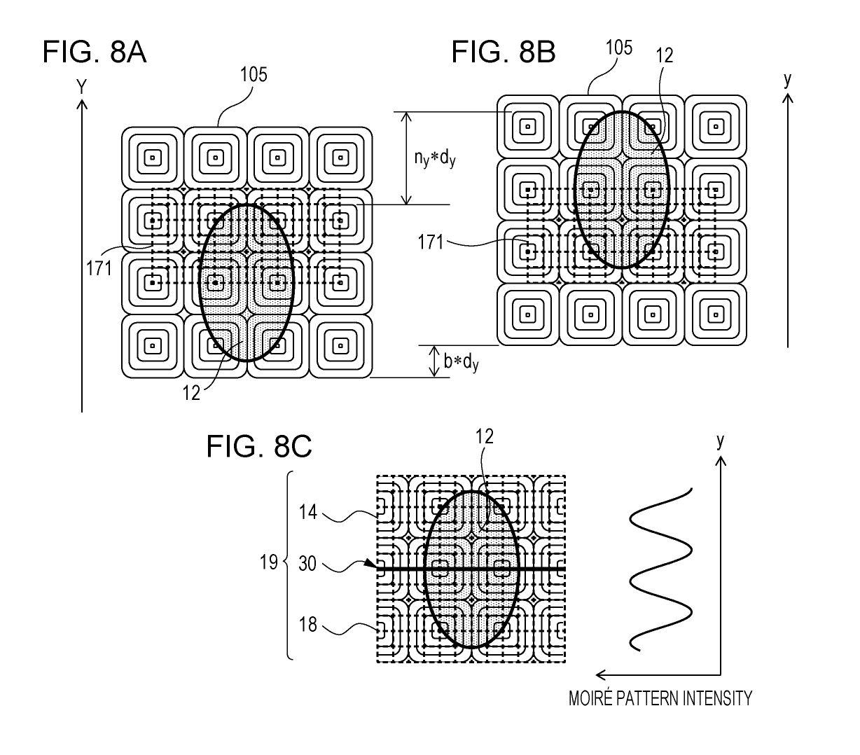

FIGS. 8A to 8C illustrate a moiré pattern 105 on the detector and an object 12 on the detector. Actually, the moiré pattern is distorted by the object, but here, the moiré pattern is not distorted for ease of illustration and only the position of the object is illustrated. When the moiré pattern 105 and the object 12 on the detector are positioned as illustrated in FIG. 8A, the detector performs detection and acquires a first detection result. In order to acquire a second detection result, the scanning unit 11 shifts the object stand 28 n_{y}×d_{y}×L3/L2 (where L3 is a distance between the X-ray generator and the object stand) in the y direction. In accordance with the shift of the object stand, the object 12 on the detector is shifted n_{y}×d_{y} in the y axis direction. Here, the detection range 171 is fixed and the relative positions of the object 12 and the measurable range are shifted n_{y}×d_{y}. In order that the first detection result pattern and the second detection result pattern have continuity, the scanning unit 11 shifts the position of the moiré pattern on the detector b_{y}×d_{y}. Here, b_{y}≠0. This shift may be performed before shifting the object and the measurable range relative to each other. FIG. 8B illustrates the positions of the moiré pattern and the object on the detector after these shifts.

FIG. 8C illustrates a synthesized-X-rays' intensity distribution 19 in which a first detection result pattern 14 and a second detection result pattern 18 are spliced together. As illustrated in FIG. 8C, the moiré patterns are smoothly spliced together at a splice 30 (indicated by a bold line) of the synthesized-X-rays' intensity distribution 19.

### Comparative Example 1

Comparative Example 1 is different from Example 1 in terms that the amount of shift of relative positions of the moiré pattern and the detection range in the y direction between the first detection and the second detection is not b_{y}×d_{y}. Other conditions of Comparative Example 1 are the same as those in Example 1.

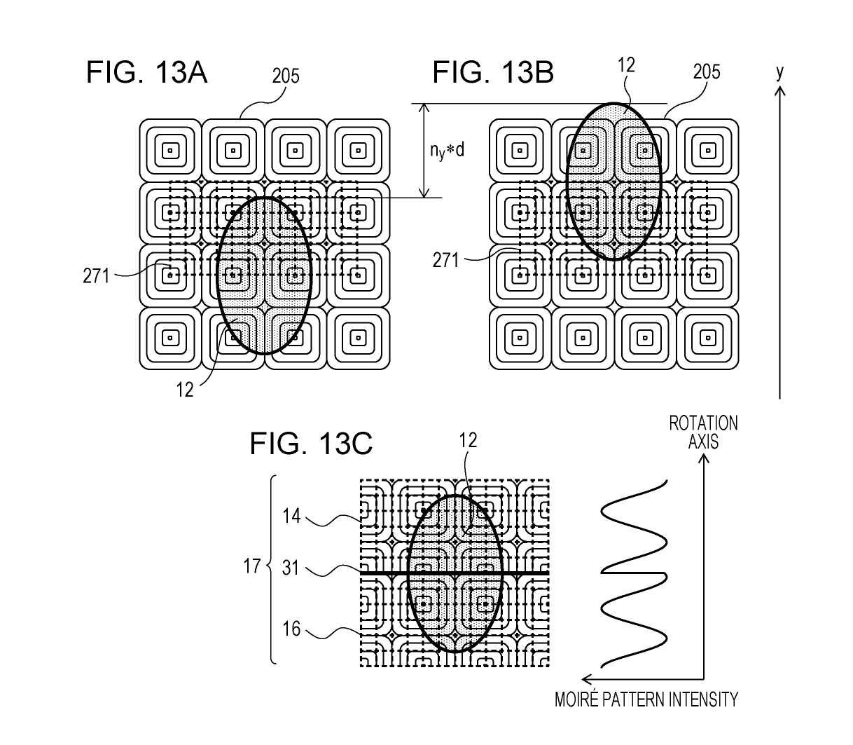

FIGS. 13A to 13C illustrate a moiré pattern 205 and an object 12 on a detection range 271. When the moiré pattern 205 and the object 12 on the detector are positioned as illustrated in FIG. 13A, the detector performs detection and acquires a first detection result of Comparative Example 1. In order to acquire a second detection result of Comparative Example 1, the scanning unit shifts the object stand in the y axis direction to shift the relative positions of the object 12 and the measurable range n_{y}×d_{y}. Since the scanning unit of Comparative Example 1 shifts only the object stand, the relative positions of the moiré pattern 205 on the detector and the detection range 271 are not shifted (FIG. 13B). When the detection range, the moiré pattern 205 on the detector, and the object 12 on the detector are positioned as illustrated in FIG. 13B, the detector performs a second detection and acquires a second detection result of Comparative Example 1. When a lower portion of the first detection result pattern 13 and an upper portion of the second detection result pattern 16 in FIG. 13A and FIG. 13B are viewed, it is found that the phases of the first and second detection result patterns in Comparative Example 1 are not continuous with each other, and thus do not have continuity. FIG. 13C illustrates a synthesized-X-rays' intensity distribution 17 of Comparative Example 1 in which the first detection result pattern 13 and the second detection result pattern 18 are spliced together.

In Comparative Example 1, the moiré patterns do not continue at the splice 31 (drawn by a bold line) of the synthesized-X-rays' intensity distribution 17, and thus the first detection result pattern and the second detection result pattern do not have continuity.

### Example 2

Example 2 is different from Example 1 in terms that the amount of shift of the relative positions of the object and the measurable range relative to each other between the first detection and the second detection is smaller than n_{y}×d_{y} and the measurable range at the first detection and the measurable range at the second detection overlap with each other on the object. Other conditions are the same as those in Example 1. The amount of the measurable ranges that overlap is one pixel of the detector. Specifically, Example 2 is an example when a=1 in the first embodiment.

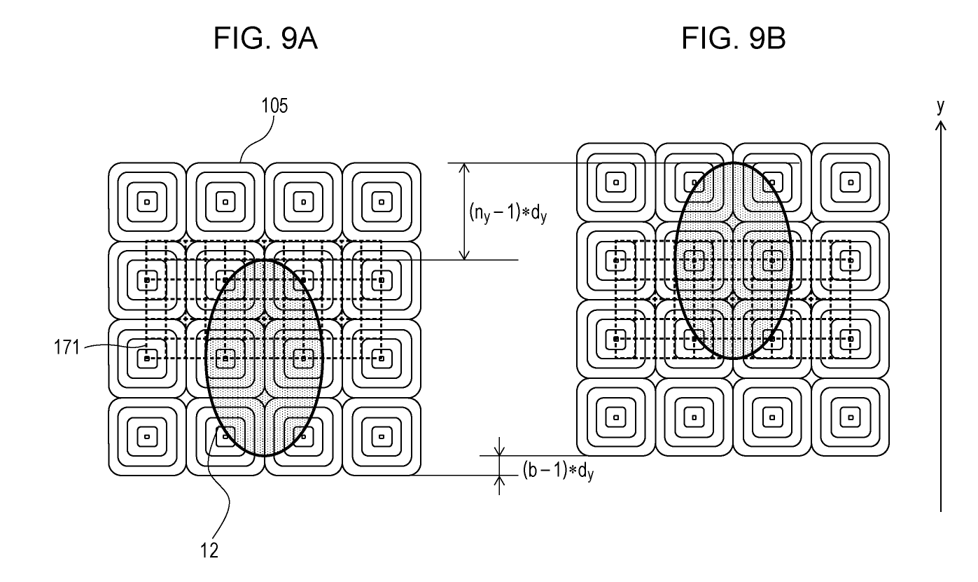

FIGS. 9A and 9B illustrate a moiré pattern 105 and an object 12 on the detecting device in Example 2. When the moiré pattern 105 and the object 12 on the detecting device are positioned as illustrated in FIG. 9A, the detector performs detection and acquires a first detection result. In order to acquire a second detection result, the scanning unit 11 shifts the object stand 28 in the y direction to shift the object 12 on the detector (n_{y}−1)×d_{y} in the y direction. Here, the detection range 171 is fixed and the relative positions of the object 12 and the measurable range are shifted (n_{y}−1)×d_{y}. The scanning unit 11 also shifts the position of the moiré pattern on the detector (b_{y}−1)×d_{y} so that the first detection result pattern 14 and the second detection result pattern 18 have continuity. Here, b_{y}≠0. In Example 2, the position of the moiré pattern is shifted by shifting a shield grating. FIG. 9B illustrates the positions of the moiré pattern and the object on the detector after these shifts. These shifts performed by the scanning unit allow the phases of a lower portion (one pixel) of the first detection result pattern 14 and an upper portion (one pixel) of the second detection result pattern 18 in FIG. 9A and FIG. 9B to agree with each other. When these overlapping portions of the first and second detection results are averaged or subjected to other operations, the accuracy of object information in these overlapping portions can be improved compared to that in the case of Example 1.

### Example 3

In Example 3, an example of the third embodiment will be described. Example 3 is different from Example 1 in terms that helical scanning is performed while an object stand is rotated, but other conditions are the same as those in Example 1. In Example 3, a case where tomography is performed N times per one rotation is described. A scanning unit shifts the object stand (n_{y}−1)×d_{y}/N in the direction of the rotation axis per rotation of the object stand at 360/N degrees. The scanning unit also shifts the shield grating b/N/M_{y}×p₂ in the direction of the rotation axis so that the relative positions of the moiré pattern and the detection range are shifted b×d_{y}/N per rotation of the object stand at 360/N degrees. Here, p₂ is a grating cycle of the shield grating. When the scanning unit shifts the object stand and the shield grating in this manner, a synthesized-X-rays' intensity distribution similar to that of Example 1 can be acquired.

### Example 4

Example 4 is different from Example 1 in terms that a line detector having nₓ pixels arranged in the x direction is used as a detector, but other conditions are the same as those in Example 1. Specifically, Example 4 is an example in which n_{y} of Example 1 is defined as one. Here, when n_{y} is one, b_{y} is one regardless of M_{y}.

When a line detector is used as a detector, the detection result pattern is a line pattern. Thus, as in the case of the Fourier transform, the use of an analysis method for acquiring object information using surrounding pixels may prevent calculation of object information in a direction perpendicular to the direction in which pixels of the detector are arranged (in other words, in a direction in which only one pixel is arranged). In Example 4, the direction perpendicular to the direction in which pixels of the detector are arranged is the y direction and examples of object information in the y direction include differential phase information and dispersion information in the y direction. In Example 4, other detection results obtained by measuring the object from the same (projection) angle after the object is shifted in the y direction are also used to calculate object information in the y direction. To this end, the patterns of the detection results (a first detection result and a second detection result) obtained by measuring the object from the same (projection) angle are required to have continuity.

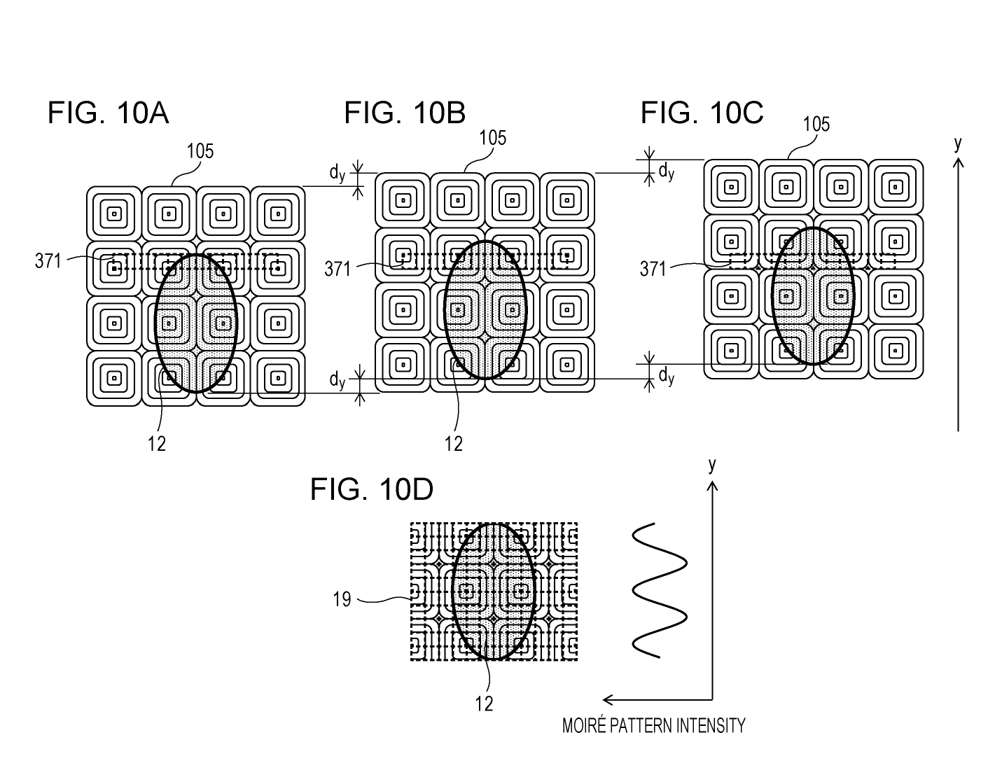

FIGS. 10A to 10D each illustrate a moiré pattern 105 and an object 12 on a detection range 371 in Example 4. When the moiré pattern 105 and the object 12 on the detector are positioned as illustrated in FIG. 10A, the detector performs detection and acquires a first detection result. In order to acquire a second detection result, the scanning unit 11 shifts the object stand 28 in the y direction. With this shift, the object 12 on the detector is shifted d_{y} in the y direction. At this time, the detection range 171 is fixed and thus the relative positions of the object 12 and the measurable range are shifted d_{y}. The scanning unit 11 also shifts the position of the moiré pattern on the detector d_{y} so that the first detection result pattern 14 and the second detection result pattern 18 have continuity. The position of the moiré pattern is shifted by shifting the shield grating. FIG. 10B illustrates the positions of the moiré pattern and the object on the detector after these shifts. When the scanning unit performs these shifts, the phases of the first detection result pattern 14 and the second detection result pattern 18 illustrated in FIG. 10A and FIG. 10B are spliced together so as to have continuity. FIG. 10C illustrates the state where the relative positions of the object and the measurable range are further shifted d_{y} and the relative positions of the detector and the moiré pattern are shifted d_{y} from the state illustrated in FIG. 10B. These relative positions are also shifted by the scanning unit shifting the object stand and the shield grating. FIG. 10D illustrates a synthesized-X-rays' intensity distribution 19 acquired as a result of repeated shifts of these positions and repeated detection and by splicing multiple detection result patterns. The synthesized-X-rays' intensity distribution 19 illustrated in FIG. 10D includes information on the entire object 12. Alternatively, use of multiple portions of a synthesized-X-rays'intensity distribution each including information on only a part of the object 12 enables acquisition of information on the entire object. Here, the synthesized-X-rays' intensity distribution is required to have information corresponding to M_{y} or more pixels in the y direction.

### Comparative Example 2

Comparative Example 2 is different from Example 4 in terms that the relative positions of the moiré pattern and the detection range in the y direction are not shifted between a first detection and a second detection. Other conditions are the same as those in Example 4.

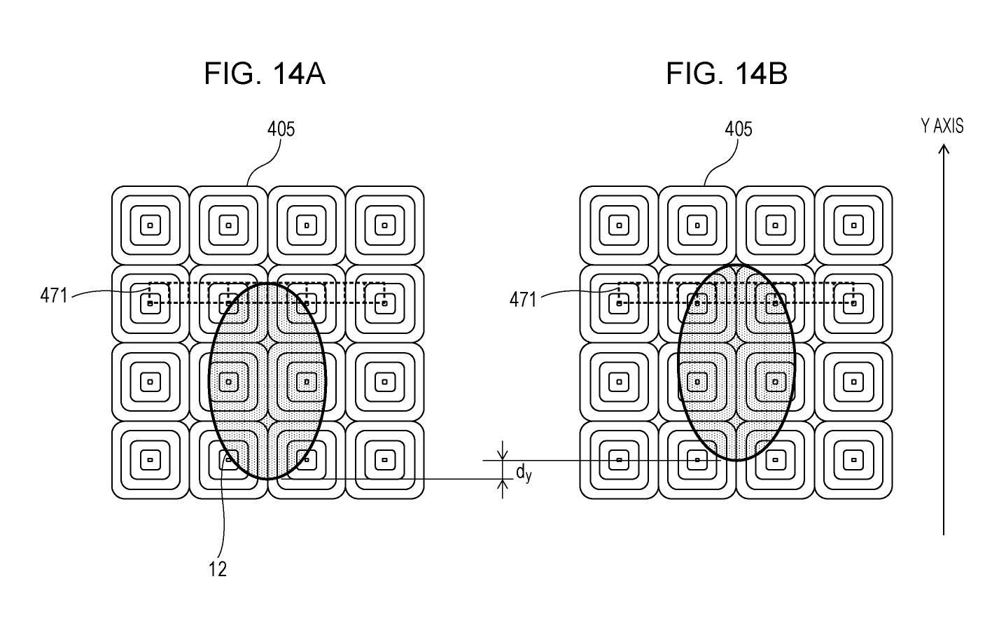

FIGS. 14A and 14B illustrates a moiré pattern 405 and an object 12 on a detection range 471. When the moiré pattern 405 and the object 12 on the detector are positioned as illustrated in FIG. 14A, the detector performs detection and acquires a first detection result of Comparative Example 2. In order to acquire a second detection result of Comparative Example 2, the scanning unit shifts the relative positions of the object 12 and the measurable range 471 d_{y} by shifting the object stand in the y direction. The scanning unit of Comparative Example 2 shifts only the object stand and does not shift the relative positions of the moiré pattern 405 and the detection range 471 on the detector (FIG. 14B). When the detection range, the moiré pattern 405 on the detector, and the object 12 on the detector are positioned as illustrated in FIG. 14B, the detection device performs a second detection and acquires a second detection result of Comparative Example 2. As viewed in FIG. 14A and FIG. 14B, the phases of first and second detection result patterns in Comparative Example 2 are not continuous with each other and thus do not have continuity. Consequently, the use of the first and second detection results of Comparative Example 2 prevents calculation of object information in the y direction.

### Example 5

Example 5 is different from Example 4 in terms that the cycle of the moiré pattern in the y direction is 8d_{y} (that is, M_{y}=8), the cycle of the moiré pattern in the x direction is 8dₓ, and a portion of the object is not measured. Other conditions are the same as those in Example 4. In Example 5, the amount by which the object and the measurable range are shifted relative to each other between the first and second detections is 2d_{y}. Specifically, Example 5 is an example in which n_{y} of Example 2 is defined as 1 and a is defined as −1.

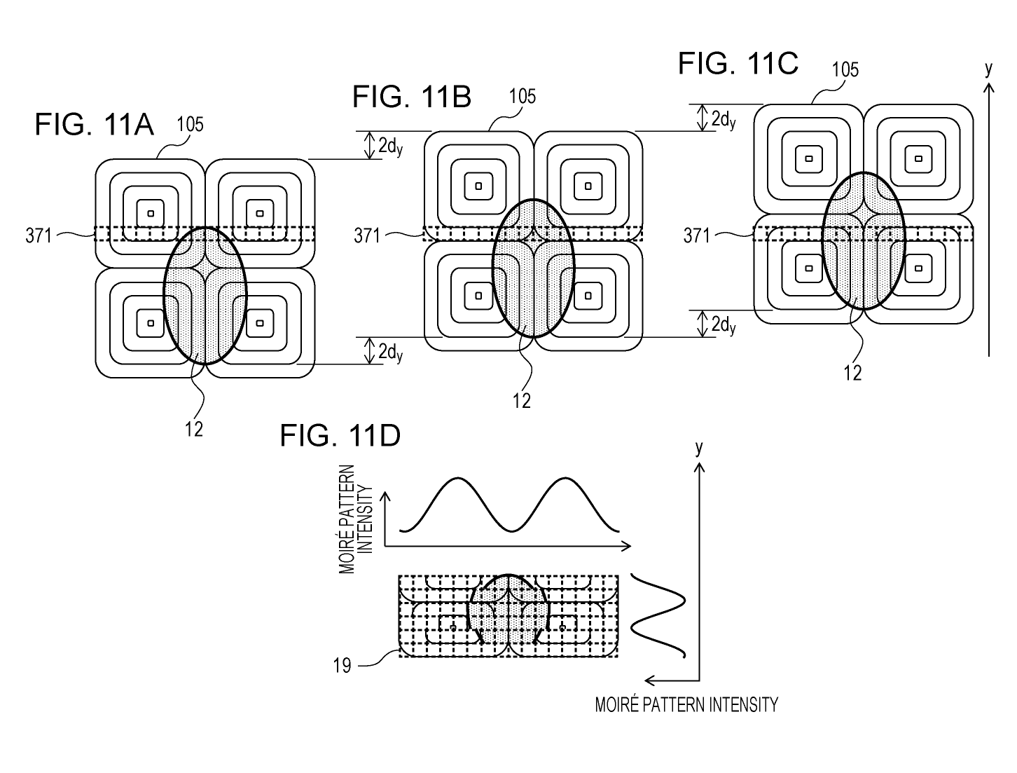

FIGS. 11A to 11D each illustrate a moiré pattern 105 and the object 12 on a detection range 371 in Example 5. When the moiré pattern 105 and the object 12 on the detector are positioned as illustrated in FIG. 11A, the detector performs detection and acquires a first detection result. The scanning unit 11 shifts the object stand 28 in the y direction to acquire a second detection result. With this shift, the object 12 on the detector is shifted 2d_{y} in the y direction. At this time, the detection range 171 is fixed and thus the relative positions of the object 12 and the measurable range are shifted 2d_{y}. The scanning unit 11 also shifts the position of the moiré pattern on the detector 2d_{y} so that the first detection result pattern 14 and the second detection result pattern 18 have continuity. The position of the moiré pattern is shifted by shifting the shield grating. FIG. 11B illustrates the positions of the moiré pattern and the object on the detector after these shifts. After the scanning unit performs these shifts, the phases of the first detection result pattern 14 and the second detection result pattern 18 in FIG. 11A and FIG. 11B are spliced together so as to have continuity. FIG. 11C illustrates the state where the relative positions of the object and the measurable range are shifted 2d_{y} and the relative positions of the detection range and the moiré pattern are shifted 2d_{y} from the state illustrated in FIG. 11B. These relative positions are shifted by the scanning unit shifting the object stand and the shield grating. FIG. 11D illustrates a synthesized-X-rays' intensity distribution 19 acquired as a result of repeated shifts of these positions and repeated detection and by splicing multiple detection result patterns. When the synthesized-X-rays' intensity distribution 19 is regarded as one moiré pattern, the cycle in the x direction is 8dₓ, whereas the cycle in the y direction is 4d_{y}. It is known that such use of patterns having different cycles in two directions enables acquisition of object information. Data may be interpolated as needed. In Example 5, although part of object information in the y direction fails to be acquired, the total number of times of measurement required to perform tomography of the entire object is halved compared to the case of Example 4.

### Example 6

Example 6 is described as an example of the third embodiment. Example 6 is different from Example 4 in terms that helical scanning is performed while the object stand is rotated. Other conditions are the same as those in Example 4. Similarly to Example 4, the cycle of the moiré pattern is 4d_{y}. In Example 4, a case where tomography is performed N times per rotation is described. The scanning unit shifts the object stand d_{y}/N in the direction of the rotation axis per rotation of the object stand at 360/N degrees. The scanning unit also shifts the shield grating in the direction of the rotation axis so that the relative positions of the moiré pattern and the detection range are shifted d_{y}/N per rotation of the object stand at 360/N degrees. After the scanning unit shifts the object stand and the shield grating in this manner, a synthesized-X-rays' intensity distribution similar to that in the case of Example 4 can be acquired.

### Example 7

Example 7 is described as an example of the second embodiment. Example 7 describes an example of a method for computing the phase information on the object using the diffraction grating and the shield grating having a two-dimensional cyclic structure.

The configuration of the interferometer is the same as the one illustrated in FIG. 3, as in the case of the second embodiment. A diffraction grating 2 has a cyclic structure in which phase progress portions and phase retardation portions are cyclically arranged at the cycle of 7.35 μm in two directions, that is, the x direction and the y direction. In Example 7, the x direction and the y direction cross perpendicularly to each other. This cyclic structure includes phase progress portions and phase retardation portions that have the same width. The phase of X-rays that have passed through the phase progress portions is a π radian ahead of the phase of X-rays that have passed through the phase retardation portions. Such a diffraction grating can be fabricated by etching a Si wafer.

The shield grating 3 has a cyclic structure in which screening portions 13 and transmission portions 1 are cyclically arranged in an area of 50 by 50 mm square at the cycle of 4.0 μm in two directions, that is, the x direction and the y direction. This shield grating 3 can be fabricated by, for example, gold-plating a resin mold, which has been fabricated by exposing a resin substrate made of a material such as silicone with X-rays so as to form a pattern.

Here, the distance between the X-ray generator 1 and the diffraction grating 2 is defined as 1,170 mm and the distance between the diffraction grating 2 and the shield grating 3 is defined as 104 mm. The detector 4 is disposed immediately behind the shield grating 3 and the pixel cycle is defined as 50 μm. Use of a lead light-shielding member as a collimator 8 limits the area irradiated with X-rays to the area in which the cyclic structure of the diffraction grating 2 and the shield grating 3 is formed.

When the diffraction grating 2 is irradiated with X-rays, the diffraction grating 2 forms an interference pattern and the interference pattern and the shield grating 3 produce a moiré pattern. When the relative positions of the diffraction grating 2 and the shield grating 3 and the angles of the directions of the cycles of the diffraction grating 2 and the shield grating 3 with respect to the detector 4 are adjusted, the cycle of the moiré pattern and the direction of the cycle can be adjusted. In Example 7, the positions of the diffraction grating, the shield grating, and the detector are adjusted so that the cycle of the moiré pattern is 200 μm, corresponding to four pixels of the detector (that is, so that M_{y}=4), and the positions are fixed by the fastening unit 5. These components serve as a gridded detector. The number n_{y} of pixels of the detector in the y direction is a multiple of four, where b_{y}=0.

The tomography performed by an image scanning apparatus of Example 7 is briefly described.

Firstly, a gridded detector is disposed at an appropriate position. The relative positions of the object and the shield grating in this state are defined as first relative positions. An X-ray generator 20 irradiates the object 12 with X-rays and a moiré pattern having a phase modulated by the object 12 is detected by the detector 4. Thus, information on the moiré pattern over the area of the shield grating corresponding to 50 by 50 mm square can be acquired. The information on the moiré pattern is defined as information on the first detection result.

Subsequently, irradiating the object with X-rays is stopped and the gridded detector is shifted perpendicularly 49 mm (245 times the cycle of the moiré pattern) to such a position that the object and the shield grating take second relative positions. The object 12 is irradiated with X-rays again and a moiré pattern that has a phase modulated by the object 12 is detected by the detector 4. The information on the moiré pattern acquired from this detection is defined as information on the second detection result.

The computation unit overlaps the acquired first and second detection results by 1 mm to splice them together.

Information of the moiré pattern thus acquired over the area corresponding to 50 mm×98 mm is defined as information on a synthesized-X-rays' intensity distribution. When phase retrieval using the Fourier transform is performed on the information on the first synthesized-X-rays' intensity distribution, phase information on the object can be computed.

Although preferable embodiments of the present invention have been described thus far, the present invention is not limited to these embodiments and these embodiments may be modified or changed within the scope of the gist of the invention. All the methods understood from the description of these embodiments, for example, methods for acquiring object information or methods for controlling an interferometer, or a program used to cause a computer to execute such methods can be included in the range of the present invention.

An interferometer that can acquire information on an object by scanning the object and that can practically desirably scan the object and an object information acquisition system including the interferometer can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An interferometer, comprising:
a diffraction grating that forms a first pattern by diffracting X-rays; a shield grating that forms a second pattern by blocking one or more of the X-rays forming the first pattern;
a detector that detects information on the second pattern by detecting X-rays from the shield grating; and
a scanning unit that shifts relative positions of an object and a measurable range in which object information can be acquired, the measurable range being within a detection range of the detector,
wherein the detector
acquires a first detection result by performing a first detection while the measurable range and the object take first relative positions, and
acquires a second detection result by performing a second detection while the measurable range and the object take second relative positions different from the first relative positions, and
wherein the scanning unit
shifts the relative positions of the measurable range and the object by shifting at least one of a position at which the second pattern is formed, the detection range of the detector, and the object, and
shifts the relative positions of the measurable range and the object so that a pattern of the first detection result and a pattern of the second detection result pattern have continuity.

2. The interferometer according to claim 1,
wherein the detector includes a plurality of pixels, and
wherein the scanning unit shifts, between the first detection and the second detection performed by the detector,
the relative positions of the measurable range and the object a distance (n_{y}−a)×d_{y}−0.1d_{y} or larger but (n_{y}−a)×d_{y}+0.1d_{y} or smaller in a y direction, and
relative positions of the second pattern and the detection range a distance (b_{y}−a)×d_{y}−0.1M_{y}×d_{y} or larger but (b_{y}−a)×d_{y}+0.1M_{y}×d_{y} or smaller in the y direction,
where d_{y} denotes a dimension of the pixels in the y direction, n_{y} denotes the number of the pixels arranged in the y direction in the measurable range, a denotes any integer, M_{y} denotes a value obtained by dividing a cycle of the second pattern in the y direction by d_{y}, and b_{y} denotes a remainder obtained by dividing n_{y} by M_{y} provided that the quotient and the remainder are integers zero or larger.

3. The interferometer according to claim 1,
wherein the detector includes a plurality of pixels, and
wherein the scanning unit shifts, between the first detection and the second detection performed by the detector, the relative positions of the measurable range and the object a distance (n_{y}−a)×d_{y}−0.1d_{y} or larger but (n_{y}−a)×d_{y}+0.1d_{y} or smaller in a y direction while relative positions of the second pattern and the detection range are fixed,
where d_{y} denotes a dimension of the pixels in the y direction, n_{y} denotes the number of the pixels arranged in the y direction in the measurable range, b_{y} denotes a remainder obtained by dividing n_{y} by M_{y} provided that the quotient and the remainder are integers zero or larger, and M_{y} denotes a value obtained by dividing a cycle of the second pattern in the y direction by d_{y}.

4. The interferometer according to claim 1,
wherein the detector includes a plurality of pixels,
wherein b_{y}=0, and
wherein relative positions of the object and the shield grating are shifted in a y direction a distance that is a first length or larger but a second length or smaller, the first length being obtained by subtracting 10% a cycle of the shield grating from a third length obtained by multiplying the cycle of the shield grating by an integer of one or larger, the second length being obtained by adding 10% the cycle of the shield grating to the third length obtained by multiplying the cycle of the shield grating by the integer,
where b_{y} denotes a remainder obtained by dividing n_{y} by M_{y} provided that a quotient and the remainder are integers zero or larger, n_{y} denotes the number of the pixels arranged in the y direction in the measurable range, and M_{y} denotes a value obtained by dividing a cycle of the second pattern in the y direction by d_{y}.

5. The interferometer according to claim 1,
wherein the detector includes a plurality of pixels,
wherein b_{y}=0, and
wherein relative positions of the object and the first pattern are shifted in a y direction a distance that is a first length or larger but a second length or smaller, the first length being obtained by subtracting 10% a cycle of the first pattern from a third length obtained by multiplying the cycle of the first pattern by an integer of one or larger, the second length being obtained by adding 10% the cycle of the first pattern to the third length obtained by multiplying the cycle of the first pattern by the integer,
where b_{y} denotes a remainder obtained by dividing n_{y} by M_{y} provided that a quotient and the remainder are integers zero or larger, n_{y} denotes the number of the pixels arranged in the y direction in the measurable range, and M_{y} denotes a value obtained by dividing a cycle of the second pattern in the y direction by d_{y}.

6. The interferometer according to claim 1,
wherein, when a dimension of a grid region of the shield grating in the y direction is defined as Y, the scanning unit shifts relative positions of the shield grating and the object in the y direction Y/2 or larger between the first detection and the second detection performed by the detector.

7. The interferometer according to claim 1, wherein the scanning unit shifts the shield grating over a surface of a sphere that has an X-ray generator at the center, the X-ray generator irradiating the diffraction grating with X-rays.

8. The interferometer according to claim 1, further comprising a fastening unit that fixes the shield grating to at least one of the diffraction grating and the detector.

9. The interferometer according to claim 8, wherein the fastening unit fixes the shield grating, the diffraction grating, and the detector together.

10. The interferometer according to claim 1, wherein each of the diffraction grating and the shield grating has cycles in two directions.

11. The interferometer according to claim 1, wherein the first pattern is formed as a result of X-rays from a transmission portion of a radiation-source grating being diffracted by the diffraction grating, the radiation-source grating including a screening portion and the transmission portion.

12. An object information acquisition system, comprising:
the interferometer according to claim 1; and
a computation unit that computes the object information using information on the first detection result and information on the second detection result,
wherein the computation unit
computes information on a first synthesized-X-rays' intensity distribution using information on at least part of the first detection result and information on at least part of the second detection result and
computes the object information using the information on the first synthesized-X-rays' intensity distribution.

13. The object information acquisition system according to claim 12, wherein the computation unit computes the object information by Fourier-transforming the information on the first synthesized-X-rays' intensity distribution.

14. The object information acquisition system according to claim 12, wherein the computation unit computes phase information of the object.

15. The object information acquisition system according to claim 12, further comprising an X-ray generator that irradiates the diffraction grating with X-rays.

16. The object information acquisition system according to claim 12, further comprising an image display unit that displays an image based on a computation result of the object information computed by the computation unit.

17. An interferometer, comprising:
a diffraction grating that forms a first pattern by diffracting X-rays;
a detector that detects information on the first pattern by detecting X-rays from the diffraction grating; and
a scanning unit that shifts relative positions of a measurable range and an object,
wherein the detector
acquires a first detection result by performing a first detection while the measurable range and the object take first relative positions, and
acquires a second detection result by performing a second detection while the measurable range and the object take second relative positions, and
wherein the scanning unit
shifts the relative positions of the measurable range and the object by shifting at least one of a position at which the first pattern is formed, a detection range of the detector, and the object, and
shifts relative positions of the position at which the first pattern is formed and the detector so that a pattern of the first detection result and a pattern of the second detection result have continuity.
